(19) United States
(12) Patent Application Publication
(10) Pub. No.: US 2011/0149913 A1
(43) Pub. Date: Jun. 23, 2011

(54) METHOD AND SERVING BASE STATION FOR DETERMINING HANDOVER TYPE, AND METHOD FOR HANDOVER BETWEEN BASE STATIONS IN WIRELESS MOBILE COMMUNICATION SYSTEM USING CARRIER AGGREGATION

(75) Inventors: Soon Gi PARK, Daejeon (KR); Yeon Seung SHIN, Daejeon (KR); Sung Gu CHOI, Daejeon (KR); Pyeong Jung SONG, Daejeon (KR); Yeong Jin KIM, Daejeon (KR); Jae Sheung SHIN, Daejeon (KR)

(73) Assignee: Electronics and Telecommunications Research Institute, Daejeon (KR)

(21) Appl. No.: 12/971,897

(22) Filed: Dec. 17, 2010

(30) Foreign Application Priority Data
Dec. 17, 2009 (KR) 10-2009-0125988
Dec. 17, 2009 (KR) 10-2009-0126044
Jun. 17, 2010 (KR) 10-2010-0057440
Jun. 17, 2010 (KR) 10-2010-0057441

(51) Int. Cl. H04W 36/30

(52) U.S. Cl. 370/332; 370/331

(57) ABSTRACT

Provided are a method and a base station for determining a handover type, and a method for handover between base stations in a wireless communication system using carrier aggregation. A serving base station may collect measurement information required to determine an optimal frequency band set from a neighboring base station and a user equipment. The serving base station may determine an optimal frequency band set for downlink handover and uplink hand over, and determine a type of the downlink handover and the uplink handover by performing data processing of the collected measurement information.

### CROSS-REFERENCE TO RELATED APPLICATIONS

This application claims the benefit of Korean Patent Application No. 10-2009-0125988, filed on Dec. 17, 2009, Korean Patent Application No. 10-2009-0126044, filed on Dec. 17, 2009, Korean Patent Application No. 10-2010-0057440, filed on Jun. 17, 2010, and Korean Patent Application No. 10-2010-0057441, filed on Jun. 17, 2010, in the Korean Intellectual Property Office, the disclosures of which are incorporated herein by reference.

### BACKGROUND

1. Field of the Invention

The present invention relates to a method and a serving base station for determining a handover type, and a method for a handover between base stations in a wireless mobile communication system using a carrier aggregation that may provide a criterion for determining a handover within a base station or a handover between base stations, based on a carrier aggregation.

2. Description of the Related Art

A mobility management method used in an existing cellular mobile communication system may perform an access mobility management through a handover, based on a determination of an algorithm managing network resources based on existing cell concepts. However, the existing mobility management method does not consider a carrier aggregation (CA) environment and thus, there is a desire for a new approach to a method of mobility management. Accordingly, there is a need to provide a mobility management method suitable for a CA environment, for example, non-matching of a coverage, non-matching of an uplink/downlink frequency, and the like.

### SUMMARY

An aspect of the present invention provides a mobility management method of a user equipment in a cellular mobile communication environment using a carrier aggregation (CA), to establish a concept of a handover between base stations and a handover within a base station, and to provide a criterion required to perform the handover.

Another aspect of the present invention also provides a method applicable to an inter-evolved nodeB (eNodeB) handover among mobility management methods of a user equipment in a cellular mobile communication environment using a CA.

According to an aspect of the present invention, there is provided a method of determining a handover type of a serving base station being currently connected by a user equipment in a wireless mobile communication system using a CA, the method including: collecting measurement information required to determine an optimal frequency band set to be used for the handover; performing data processing of the collected measurement information to determine a temporary frequency band set for a downlink handover or an uplink handover; and determining the optimal frequency band set for the downlink handover or the uplink handover, depending on whether the determined temporary frequency band set supported by the serving base station and whether the determined temporary frequency band set supported by a neighboring base station of the serving base station.

The collecting may include collecting, by the serving base station, information measured by the user equipment using a Radio Resource Control (RRC) interface, information measured within the serving base station, received using a Control Service Access Point (CSAP) interface, and resource information of the neighboring base station using an X2 interface.

The performing of the data processing may include performing radio condition related processing, traffic load processing, and interference related processing based on the collected measurement information.

When the determined temporary frequency band set corresponds to the optimal frequency band set for the downlink handover and supported by the neighboring base station, the determining of the optimal frequency band set may include selecting, from the neighboring base station or the serving base station, the optimal frequency band set for the uplink handover.

The method may further include determining a type of the downlink handover based on a number of frequency bands with respect to a downlink being currently used by the user equipment and a number of frequency bands included in an optimal frequency band set with respect to the downlink when the optimal frequency band set for the uplink handover is selected from the neighboring base station.

The method may further include determining a type of the uplink handover based on a number of frequency bands with respect to an uplink being currently used by the user equipment and a number of frequency bands included in an optimal frequency band set with respect to the uplink.

When the determined temporary frequency band set corresponds to the optimal frequency band set for the uplink handover and supported by the neighboring base station, the determining of the optimal frequency band set may include selecting, from the neighboring base station or the serving base station, the optimal frequency band set for the downlink handover.

The method may further include determining a type of the downlink handover based on a number of frequency bands with respect to a downlink being currently used by the user equipment and a number of frequency bands included in an optimal frequency band set with respect to the downlink when the optimal frequency band set for the downlink handover is selected from the neighboring base station.

The method may further include determining a type of the uplink handover based on a number of frequency bands with respect to an uplink being currently used by the user equipment and a number of frequency bands included in an optimal frequency band set with respect to the uplink.

According to another aspect of the present invention, there is provided a serving base station for determining a type of a handover type of a user equipment in a wireless mobile communication system using a CA, the serving base station including: a collecting unit to collect measurement information required to determine an optimal frequency band set to be used for the handover; a data processor to perform data processing of the collected measurement information, and to thereby determine a temporary frequency band set for a downlink handover or an uplink handover; and a determining unit to determine the optimal frequency band set for the downlink handover or the uplink handover, depending on whether the determined temporary frequency band set supported by the serving base station and whether the determined temporary frequency band set supported by a neighboring base station of the serving base station.

The collecting unit may collect information measured by the user equipment using a Radio Resource Control (RRC) interface, information measured within the serving base station, received using a Control Service Access Point (CSAP) interface, and resource information of the neighboring base station using an X2 interface.

The data processor may perform radio condition related processing, traffic load processing, and interference related processing based on the collected measurement information.

When the determined temporary frequency band set corresponds to the optimal frequency band set for the downlink handover and supported by the neighboring base station, the determining unit may select, from the neighboring base station or the serving base station, the optimal frequency band set for the uplink handover.

When the determined temporary frequency band set corresponds to the optimal frequency band set for the uplink handover and supported by the neighboring base station, the determining unit may select, from the neighboring base station or the serving base station, the optimal frequency band set for the downlink handover.

According to still another aspect of the present invention, there is provided a method for a handover between base stations in a wireless mobile communication system using a CA, the method including: receiving and storing measurement information associated with neighboring base stations positioned around a serving base station; analyzing the measurement information to determine, as a candidate group, resources of neighboring base stations having a downlink quality greater than a reference value; reserving a resource of a neighboring base station having a greatest downlink quality in the candidate group as a resource to be used for a handover of a user equipment; performing the handover of the user equipment to the neighboring base station having the greatest downlink quality through the reserved resource; and cancelling the reserved resource when the downlink quality of the reserved resource becomes to be less than the reference value.

According to yet another aspect of the present invention, there is provided a method for an inter-eNodeB handover in a wireless mobile communication system using a CA, the method including: storing and processing measurement information received using an RRC interface and a CSAP interface; performing inter-eNodeB information exchange and resource preparation using an X2 interface; and determining a target eNodeB based on the measurement information and a resource preparation state of a neighboring eNodeB to perform a handover. When determining the target eNodeB in a candidate group of a final stage, history information regarding inter-eNodeB handover may be used for a handover decision.

The received measurement information may include downlink measurement information for each CC with respect to current serving eNodeB and neighboring base stations, and may additionally include information in an aspect of policy and uplink measurement information measured in source eNodeB.

The history information may store information regarding a serving base station of a user equipment while the user equipment is moving between eNodeBs in a state where the user equipment is wirelessly connected to a network. The information may include a CA ID associated with each component carrier (CC) associated with a frequency bandwidth. The CA ID is defined herein as an ID that can include information for separating the frequency bandwidth and globally uniquely identify a (DL) CC of corresponding eNodeB. However, it is only an example and thus, the CA ID may be modified in any type and thereby be used.

Specifically, the CA ID includes information regarding which base station includes which frequency bandwidth (which CC) and thereby may globally uniquely identify a CC of a corresponding base station. The history information may include a previous serving base station CA ID that is information of a previous serving base station while the user equipment is moving to another base station (eNodeB), a cell type, a duration time, downlink signal-to-noise (SNR) quality information of a current serving base station and the previous serving base station at a point in time of movement, and the like.

The history information may be recorded by the current serving base station. In the case of handover through X2AP, previous record may be handed over. Also, the history information may be transferred by using the user equipment as a medium, through a handover message of an RRC protocol and a handover complete message.

When the history information is transferred through the X2AP, the history information may be transferred through a message design for a new signal of X2AP of the user equipment or using existing handover related message.

The method may further include: analyzing, for each CC based on the stored history information, a frequency of the user equipment from current CA to another CA when the inter-eNodeB handover of the user equipment is determined; and performing the handover to a CA having a greatest frequency of the user equipment.

The method may further include determining the handover as an unnecessary handover and maintaining a CC set being currently used by the user equipment, when a duration time of the user equipment in the CA having the greatest frequency is less than a predetermined reference value, or when the handover having a relatively short duration time is frequently performed while a radio quality approaching a predetermined reference value.

According to a further another aspect of the present invention, there is provided a method for an inter-eNodeB handover in a wireless mobile communication system using a CA, the method including: determining, by a source base station to determine a CC set to be assigned to a user equipment when a handover preparation process for requesting handover between base stations is not performed; preparing a call preparation process through a handover request between the source base station and neighboring base stations and an acceptance of the handover request; and performing a handover by assigning, to the user equipment, one of CC sets received from the neighboring base stations when the determined CC set is different from the received CC sets.

The performing may include: performing again the call preparation process when a signal quality of the determined CC set is less than a signal quality of the received CC set; and performing the handover by assigning, to the user equipment, a CC set having a greatest signal quality among the CC sets received from the neighboring base stations.

Among the CC sets received from the neighboring base stations, all the CC sets having a signal quality greater than a minimum signal quality of each CC of the source base station may be assigned to the user equipment.

### Effect

According to embodiments of the present invention, when performing a mobility management of a user equipment in a carrier aggregation (CA) environment, for example, when performing inter-evolved NodeB (eNodeB) handover (HO), it is possible to decrease an unnecessary handover and make a robust handover.

Also, according to embodiments of the present invention, by providing a criterion required for determining a type of a handover based on a CA environment, it is possible to increase a system capacity, and to effectively perform a handover within a base station or a handover between base stations.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a network system according to an embodiment of the present invention;

FIG. 2 is a diagram illustrating an example of expressing, as Distributed Radio Resource Management (D-RRM), a logical entity in charge of user equipment mobility management within a base station according to an embodiment of the present invention;

FIG. 3 is a diagram to describe a control portion of a D-RRM according to an embodiment of the present invention;

FIG. 4 is a diagram to describe a frequency reuse characteristic according to an embodiment of the present invention;

FIG. 5 is a diagram to describe carrier aggregation (CA) according to an embodiment of the present invention;

FIG. 6 is a diagram illustrating another embodiment of component carrier (CC) planning for CA according to an embodiment of the present invention;

FIG. 7 is a diagram to describe a case where non-matching of an up/down cell occurs in CC planning according to an embodiment of the present invention;

FIG. 8 is a diagram to describe a type of handover used in a CA environment according to an embodiment of the present invention;

FIG. 9 is a flowchart to describe a method of determining CC to be used for handover based on a DLENODEBCCSNR measurement value according to an embodiment of the present invention;

FIG. 10 is a flowchart to describe a process of determining a type of DL CA handover according to change of a DL Best CC set (BCcc) in inter-eNodeB HO according to an embodiment of the present invention;

FIG. 11 is a flowchart to describe a process of determining a type of UL CA handover according to change of UL BCcc when inter-eNodeB HO is performed according to an embodiment of the present invention;

FIG. 12 is a flowchart to describe a process of determining a type of DL CA handover according to change of DL BCcc when intra-eNodeB HO is performed according to an embodiment of the present invention;

FIG. 13 is a flowchart to describe a process of determining a type of UL CA handover according to change of UL BCcc when intra-eNodeB HO is performed according to an embodiment of the present invention;

FIG. 14 is a flowchart to describe a method of determining a type of a handover of a serving base station being currently connected by a user equipment according to an embodiment of the present invention;

FIG. 15 is a block diagram illustrating a serving base station for determining a type of a handover of a user equipment in a wireless mobile communication system using a CA according to an embodiment of the present invention;

FIG. 16 and FIG. 17 are diagrams to describe a method of automatically reserving and cancelling a resource in a CA environment according to an embodiment of the present invention;

FIG. 18 is a diagram illustrating an example of a mobility scenario of a user equipment according to an embodiment of the present invention;

FIG. 19 is a flowchart to describe a process of applying inter-eNodeB HO;

FIG. 20A through FIG. 20C are flowcharts in neighboring (target) eNodeB according to an embodiment of the present invention;

FIG. 21A and FIG. 21B are flowcharts in serving (source) eNodeB according to an embodiment of the present invention;

FIG. 22 is a diagram to describe a process of storing history information according to an embodiment of the present invention; and

FIG. 23 through FIG. 25 are flowcharts to describe operation 2112 of FIG. 21A according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

When it is determined detailed description related to a related known function or configuration they may make the purpose of the present invention unnecessarily ambiguous in describing the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

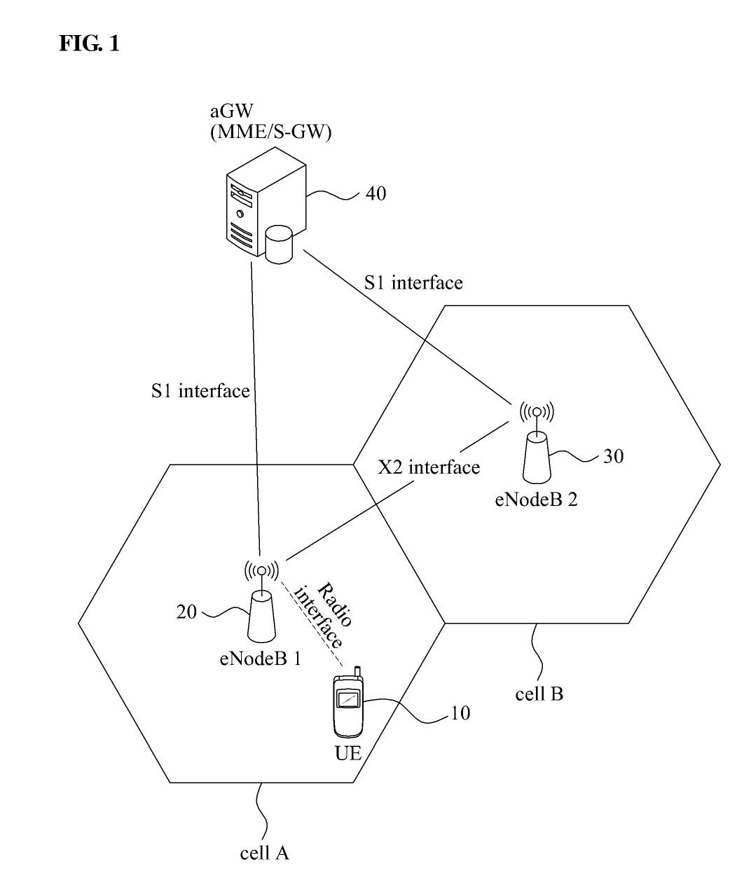

FIG. 1 is a diagram illustrating a network system according to an embodiment of the present invention.

Hereinafter, the network system will be described based on a next generation mobile communication system including, as technology applicable to all the cellular mobile communication systems, a 3^{rd} Generation Partnership Project (3GPP) Long Term Evolution (LTE) structure and an International Mobile Telecommunication (IMT)-Advanced structure.

In the network system of FIG. 1, as the 3GPP LTE structure, evolved NodeB (eNodeB) indicates a base station and corresponds to a node similar to ‘NodeB+RNC’ in Wideband Code Division Multiple Access (WCDMA). An eNodeB (1) 20 is positioned in a center of a cell A, and an eNodeB (2) 30 is positioned in a center of a cell B.

An access gateway (aGW) 40 may include a Mobility Management Entity (MME) and an SAE gateway (S-GW). The aGW 40 denotes a mobile communication system management entity. The aGW 40 corresponds to a node similar to a serving General Packet Radio Service (GPRS) support node (SGSN) and a gateway GPRS support node (GGSN) in WCDMA. A user equipment (UE) 10 may be a communicable mobile station, for example, a mobile phone, a laptop, a notebook, and the like.

From viewpoint of eNodeB, a radio interface between the eNodeB (1) 20 and the UE 10, an X2 interface between the eNodeB (1) 20 and the eNodeB (2) 30, and an S1 interface between the eNodeB (2) 30 and the aGW 40 exist. From viewpoint of a control plane of a Radio Network Layer (RNL), the radio interface may be referred to as a Radio Resource Control (RRC) interface, the S1 interface may be referred to as an S1 Application Part (S1AP) interface, and the X2 interface may be referred to as an X2AP interface. The above interface may be defined as a protocol. Procedures for each function may be defined. Messages to be used, information associated with each of the messages, and the like may be defined in a corresponding procedure.

Generally, 3GPP series may perform mobility management of a Network Controlled Mobile Assisted (NCMA) type. Specifically, in the case of the 3GPP series, a network (eNodeB in FIG. 1) may perform handover prediction, handover decision, and handover optimization, and a mobile (e.g., UE) may assist a mobility management function of the network. In the case of an LTE and an LTE-Advanced structure of 3GPP series, mobility management within Radio Access Technology (RAT) may be based on an NCMA concept. In a cellular mobile communication, when a logical exclusive radio channel between a UE and eNodeB is present, the UE may be defined to be in a connected state. In the connected state of the UE, the mobility management may be handled by a serving base station (eNodeB) being currently accessed by the UE. The serving base station (eNodeB) may support the mobility management of the UE using cooperation through X2AP signaling with neighboring base stations, information measured by the UE, and measurement information within the serving base station (eNodeB).

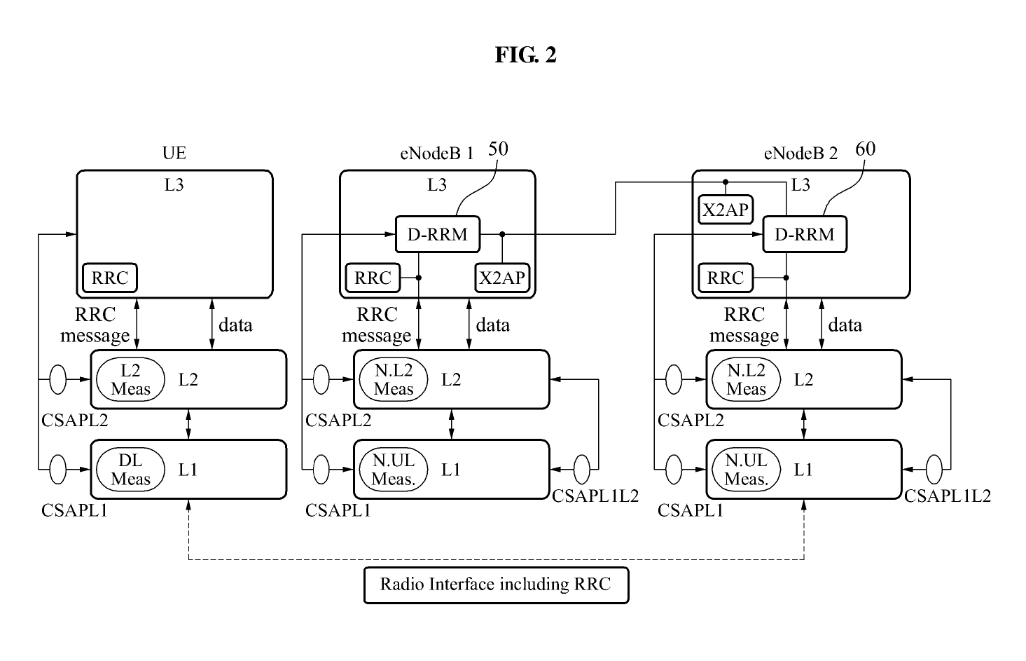

FIG. 2 is a diagram illustrating an example of expressing, as Distributed Radio Resource Management (D-RRM), a logical entity in charge of a UE mobility management within a base station (eNodeB) according to an embodiment of the present invention. For example, the D-RRM may exist for each eNodeB, and distributed resource management may be oriented.

Referring to FIG. 2, D-RRM 50 is positioned in a layer (L3) of eNodeB 1, and D-RRM 60 is positioned in L3 of eNodeB 2. Each of the D-RRMs 50 and 60 is connected to RRC through a radio interface with a UE. Each of the eNodeB 1 and the eNodeB 2 is connected to an X2AP. For resource control and radio measurement with respect to a layer 1 (L1) and a layer 2 (L2) within a corresponding base station (eNodeB), each of the D-RRM 50 and 60 may have Control Service Access Point (CSAP) interfaces (CSAPL1, CSAPL2). In addition, a CSAPL1L2 interface may exist between the L1 and the L2.

Accordingly, each of the D-RRMs 50 and 60 may control a resource of the UE through signaling using an RRC protocol between each of the eNodeB 1 and the eNodeB 2 and the UE, or may receive a report about a measurement with respect to circumstances (DL Meas, L2 Meas) in the UE. Here, DL Meas indicates a downlink measurement and L2 Meas indicates an L2 measurement.

The D-RRM 50 may interface with an MME through signaling using an S1AP protocol, and may interface with neighboring eNodeB through signaling using an X2AP protocol. Also, the D-RRM 50 may receive a report about resource control and measurement (N.UL Meas, N.L2 Meas) within eNodeB through CSAPL1 and CSAPL2 within the eNodeB. Here, N.UL Meas indicates a network uplink measurement and N.L2 Meas indicates a network L2 measurement.

Accordingly, the D-RRM 50 may perform integral and systematical mobility management based on information obtained using the aforementioned various interfaces.

The aforementioned function of the D-RRM 50 performing the integral and systematical mobility management is herein referred to as Connection Mobility Control (CMC), which will be described later. In addition to the CMC, The D-RRM 50 may include a Traffic and Load Control (TLC) function and an Interference Coordination Control (ICC) function. The mobility management in the CMC based on the TLC and the ICC will be further described.

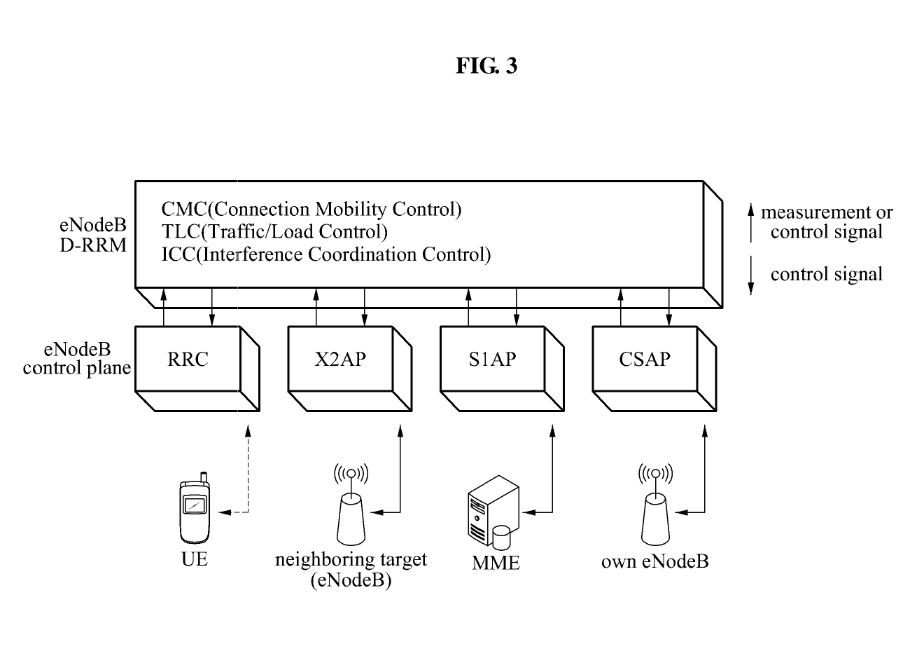

FIG. 3 is a diagram to describe a measurement and control signaling of a D-RRM according to an embodiment of the present invention.

Referring to FIG. 3, the D-RRM may interface with UE, neighboring eNodeB, MME, and lower layers (L1, L2) within eNodeB of the D-RRM through RRC, X2AP, S1AP, and CSAP. The D-RRM may monitor each UE circumstance (e.g., DL Meas of L1 and L2 Meas of L2 in the UE of FIG. 2) and a circumstance of the eNodeB of the D-RRM (e.g., N.L2 Meas of L2 and N.UL Meas in the eNodeB of FIG. 2) using an RRC protocol and CSAP, and may control a measurement scheme at the same time.

The RRC protocol and CSAP may be used for mobility management. The S1AP that is an interface protocol between the eNodeB and the MME may be used to perform a portion of a mobility management function (e.g., a change of a data path and a signal between eNodeB and aGW according to change of eNodeB). The X2AP may be used to perform a portion of the mobility management function (e.g., handover preparation and exchanging of handover information between base stations).

Specifically, the RRC corresponds to an interface protocol between the UE and the eNodeB, and the X2AP corresponds to an interface protocol between the eNodeB and another eNodeB. The CSAP corresponds to a Control Service Access Point between L1 (PHY) and L2 (Media Access Control (MAC), RLC, Packet Data Convergence Protocol (PDCP), and GPRS Tunneling Protocol (GTP)) of the eNodeB of the CSAP. The S1AP corresponds to an interface protocol between the eNodeB and the MME.

From viewpoint of a control standard protocol and a local interface, the RRC, the X2AP, the SLAP, and the CSAP correspond to a control plane. Measurement monitoring and control may be for quick and robust handover in an aspect of general mobility management. The D-RRM may perform handover prediction, handover decision, handover coordination, and handover optimization using the aforementioned interfaces.

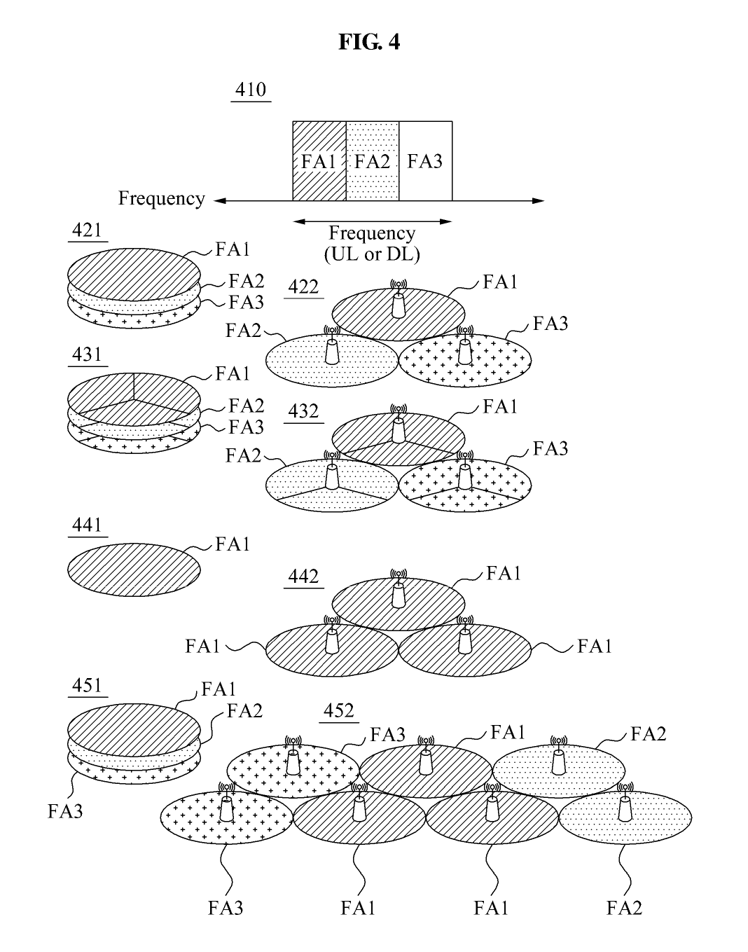

FIG. 4 through FIG. 6 are diagrams to more clearly define terms and technologies employed by the present invention in describing a mobility management method in a CA concept, and to describe a frequency reuse.

FIG. 4 is a diagram to describe a frequency reuse characteristic according to an embodiment of the present invention.

Referring to FIG. 4, ‘frequency’ used in a diagram 410 indicates a frequency bandwidth assigned to a mobile communication provider so as to provide a mobile communication service using a radio transmission scheme. The assigned frequency bandwidth is for uplink (UL) or downlink (DL). For example, when it is assumed that the mobile communication provider is assigned with the frequency bandwidth with respect to the DL or the UL, a base station may separate the assigned frequency bandwidth into a plurality of frequency assignments FA1, FA2, and FA3 based on a characteristic of the radio transmission scheme desired to be serviced by the base station.

A diagram 421 shows the frequency bandwidth separated into FA1, FA2, and FA3. As shown in a diagram 422, when inter-cell interference exists, it is possible to prevent the interference by performing cell planning of using a frequency reuse factor as “3”.

A diagram 431 shows a case where a cell is sectored using a directional antennal to increase a total data throughput of the cell in a single base station. Here, each of FA1, FA2, and FA3 is sectored into three sectors by employing the directional antennal with respect to the single base station. A diagram 432 shows an embodiment of planning the cell of the diagram 431.

A diagram 441 illustrates an example of cell planning using only FA1 when interference does not exist due to the characteristic of the radio transmission scheme. In this case, a frequency reuse factor of FA1 is “1” as shown in a diagram 442.

A diagram 451 illustrates an example of a mobile communication provider assigned with frequencies of FA2 and FA3 even though inter-cell interference does not exist, and a diagram 452 illustrates an example of cell planning in the case of the diagram 451. In a case where each cell employs the same radio scheme, when a wirelessly connected UE moves from an FA1 cell to another FA1 cell, this movement may be defined as intra-frequency handover. When the UE moves from one cell to a different cell such as movement from a FA1 cell to a FA2 cell, this movement may be defined as inter-frequency handover. In FIG. 1, the relationship between the cell A and the cell B may be the same FA or different FAs.

As described above, a frequency reuse factor may be set to “1” when inter-cell interference does not exist. When the inter-cell interference exists due to a radio transmission scheme, cell planning may be performed so that the frequency reuse factor may be at least “1” by dividing the frequency bandwidth assigned to the mobile communication provider, or a separate interference alignment scheme may be employed while setting the frequency reuse factor to “1”. Even though the radio access scheme does not cause the inter-cell interference, it is possible to divide the assigned frequency bandwidth and thereby use the divided frequency bandwidth.

Among major terms used in a carrier aggregation (CA) environment, a component carrier (CC) corresponds to an available frequency band and herein indicates an available frequency band used for a CA. The term “CA” indicates a set of CCs simultaneously operable when transmitting and receiving data between a base station and a UE, or a concept of a possible simultaneous operation of the CCs.

For example, from viewpoint of a base station, CC1, CC2, and CC3 may be used for a downlink, and CC4, CC5, and CC6 may be used for an uplink. Based on CA capability of UE connected to the above base station, the UE may substantially use CC1 and CC2 for the downlink, and use CC4 and CC6 for the uplink. With the above assumption, a CC set being used by the UE (UCcc) may be defined as DL {CC1, CC2} and UL {CC4, CC6}.

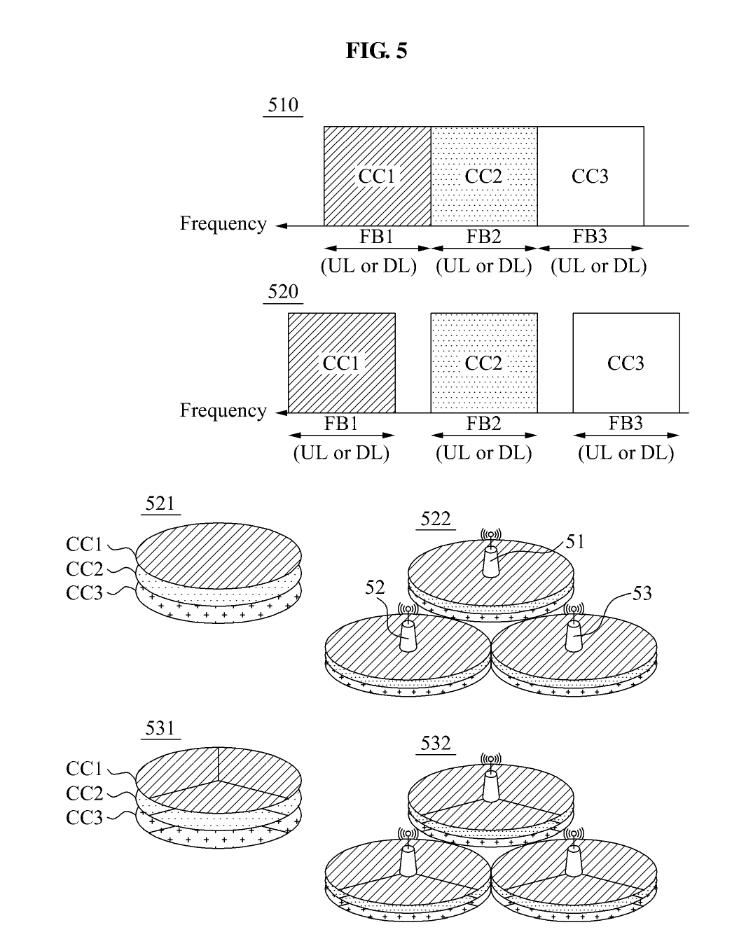

When a single available frequency carrier is CC in FIG. 5, CC technology enables a single base station to simultaneously use a plurality of CCs (e.g., CC1, CC2, and CC3) based on a frequency bandwidth.

The term “CC set” used herein may indicate a set of frequency bands available in the same base station for CA. The CA may indicate a set of CCs simultaneously operable in the single base station or a possible simultaneous operation of the CCs in the same base station. Each of an UL CC set and a DL CC set may be defined.

CC1, CC2, and CC3 may be consecutively assigned as shown in a diagram 510, or may be inconsecutively assigned as shown in a diagram 520 to thereby have different frequency bandwidths, for example, FB1, FB2, and FB3. Also, all of CC1, CC2, and CC3 may be assigned to a single provider, or a portion thereof may be assigned to different providers.

When a radio access scheme where interference does not exist or an interference alignment scheme exists, CC1, CC2, and CC3 of a diagram 521 may have the same cell coverage as shown in a diagram 522. CC planning may be performed for each of base stations 51, 52, and 53 so that CC1, CC2, and CC3 may be simultaneously operated in a single base station, for example, the base station 51. This may indicate that the single base station, for example, the base station 51 may transfer data using all of CC1, CC2, and CC3 based on a performance of a terminal, that is, a UE.

As shown in a diagram 531, it is possible to increase a total data throughput of the same base station by sectoring CC1, CC2, and CC3. Cell planning of a diagram 532 may be performed.

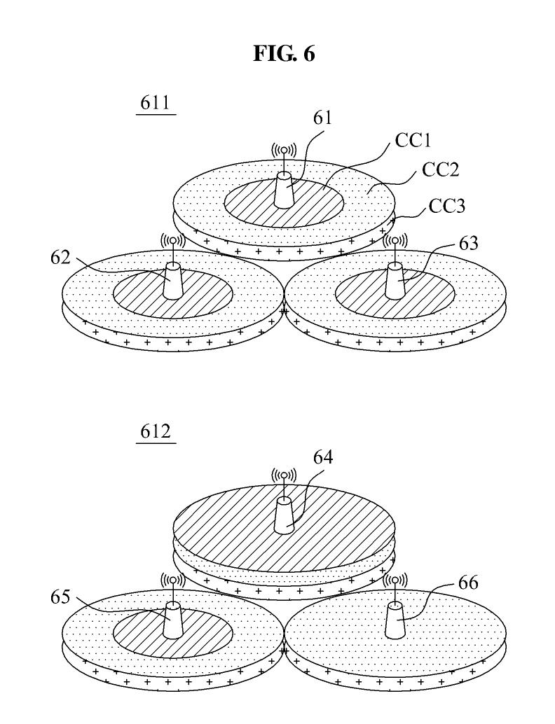

FIG. 6 is a diagram illustrating another embodiment of CC planning in addition to the CA environment of FIG. 5 according to an embodiment of the present invention.

Referring to FIG. 6, CC planning for CA may not have the same CC coverage, which is different from the diagram 522 or 532 of FIG. 5. A number of CC sets for each base station may be different.

A diagram 611 illustrates an example of CC planning where a coverage of CC1 is smaller than a coverage of CC2 and CC3 in all the base stations 61, 62, and 63. A diagram 612 illustrates an example of CC planning where all of CC1, CC2, and CC3 have the same coverage in a base station 64, a coverage of CC1 is smaller than a coverage of CC2 and CC3 in a base station 65, and CC1 is absent in a base station 66.

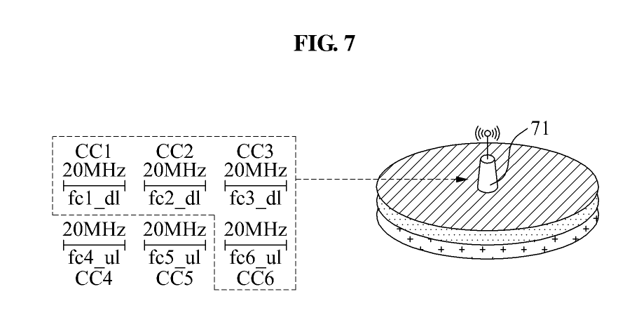

FIG. 7 is a diagram to describe an example where a number of UL CC sets and a number of DL CC sets, that is, a number of up/down CC sets are not matched in addition to the CA environment described above with reference to FIG. 5 and FIG. 6, according to an embodiment of the present invention.

In an existing cell concept, a UL frequency bandwidth and a DL frequency bandwidth may constitute a single pair, and a cell is described based on a DL coverage in FIG. 5 and FIG. 6. This suggestively includes that the UL frequency bandwidth and the DL frequency bandwidth are the same as each other and constitute a single pair.

However, in the CA environment, when a CA technology is applied to a single base station 71, a number of frequency bands for DL may be different from a number of frequency bands for UL. As shown in FIG. 7, the base station 71 may use a plurality of frequency bands fc1_d1, fc2_d1, and fc3_d1 for DL, and may asymmetrically use only a single frequency band fc6_u1 for UL. Here, “asymmetrically” may include that a number of UL CC sets and a number of DL CC sets are not matched, or a UL frequency bandwidth and a DL frequency bandwidth are different. A frequency bandwidth 20 MHz of FIG. 7 is only an example and thus, the frequency bandwidth may be greater than or less than 20 MHz.

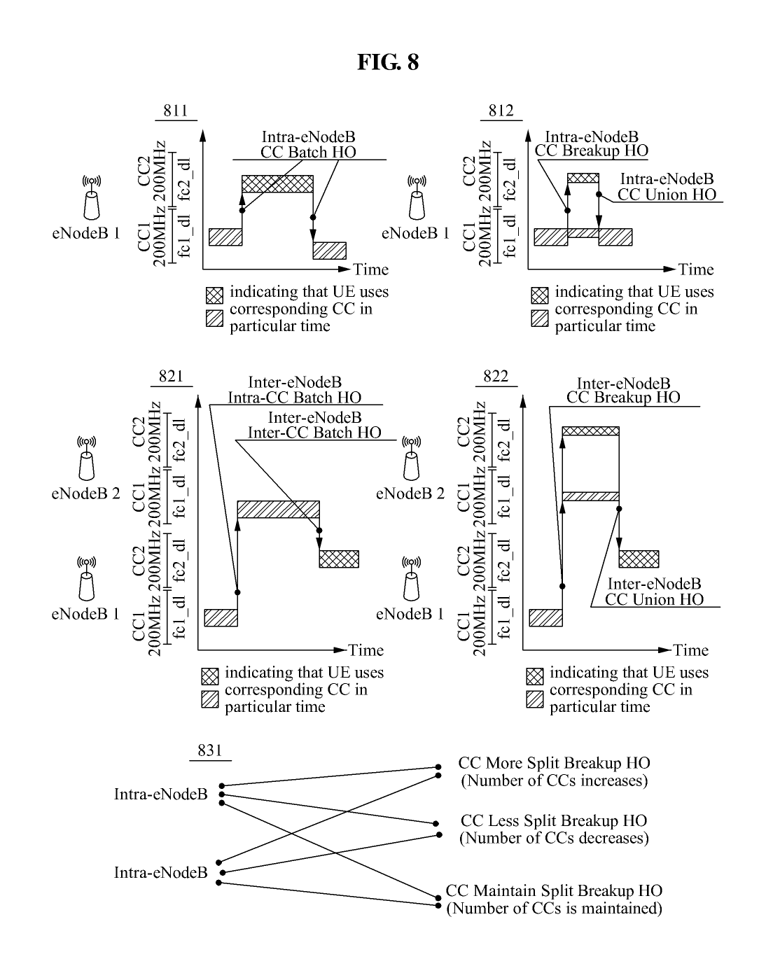

FIG. 8 is a diagram to describe a type of handover that may be defined in the aforementioned various CA environments according to an embodiment of the present invention.

Diagrams 811 and 812 show a handover between CC sets (CC1 and CC2) operated in the same base station (eNodeB 1), which is referred to as Intra-eNodeB Batch HO.

Referring to the diagram 811, since a UE uses CC2 while using CC1, first Intra-eNodeB Batch HO occurs. Since the UE uses CC1 while using CC2, second Intra-eNodeB Batch HO occurs.

Referring to the diagram 812, a first type corresponds to Intra-eNodeB CC Breakup HO that the UE simultaneously uses two CC sets (CC1 and CC2) while using only a single CC (CC1). A second type corresponds to Intra-eNodeB CC Union HO that the UE uses only a single CC (CC1) while simultaneously using two CC sets (CC1 and CC2).

Diagrams 821 and 822 show a handover between base stations based on a CC circumstance. Referring to the diagram 821, a first type corresponds to Inter-eNodeB Intra-CC Batch HO that the UE moves to CC1 of another base station (eNodeB 2) while using single CC1 in a previous base station (eNodeB 1). A second type corresponds to Inter-eNodeB Inter-CC Batch HO that the UE moves to CC2 of another base station (eNodeB1) while using CC1 in a single base station (eNodeB 2).

Referring to the diagram 822, a first type corresponds to Inter-eNodeB CC Breakup HO that the UE uses CC1 and CC2 for handover to another base station (eNodeB 2) while using CC1 in a previous base station (eNodeB1). A second type corresponds to Inter-eNodeB CC Union HO that the UE uses only single CC1 of another base station (eNodeB 1) while using CC1 and CC2 in a single base station (eNodeB 2).

A diagram 831 shows CC More Split Breakup HO where the UE uses additional CC while using at least one CC, CC Less Split Breakup HO where a number of CCs decreases, and CC Maintain Split Breakup HO where a number of CCs is maintained in a handover. A call of the diagram 831 is referred to as a split phenomenon. The split phenomenon may occur in Intra-eNodeB or in Inter-eNodeB.

Generally, in handover, UL and DL may constitute a pair. UL handover may also be performed based on DL. The handover of FIG. 8 is described based on DL. When considering the aforementioned CA environments, UL handover and DL handover may be independently performed or performed together in Intra-eNodeB. Also, even though the UL handover and the DL handover may need to be simultaneously performed in Inter-eNodeB, the UL handover and the DL handover may not be simultaneously performed in the case of a handover of a split type or a union type.

[Handover Process]

Hereinafter, a handover process will be described by separating the handover process into three operations.

A first operation corresponds to a measurement monitoring and information collecting operation. A D-RRM of a framework as shown in FIG. 2 may collect UE measurement information through RRC, may collect measurement information associated with eNodeB of the D-RRM through CSAP, and may perform resource preparation and information exchange with neighboring eNodeBs through X2AP. For example, the measurement information may be obtained by measuring a radio link. The measurement information may be processed based on a role of each function of the D-RRM (e.g., CMC, TLC, ICC, and the like).

A second operation corresponds to a handover preparation and decision operation. CMC may prepare currently available CC sets based on processed data, and may determine whether handover is to be substantially performed.

A third operation corresponds to a handover execution operation. A UE may be handed over at an appropriate point in time and thereby be moved to another eNodeB, i.e., a different cell to establish a new connection.

Selectively, in the second operation, CMC may accept a request of TLC or ICC and thereby perform the handover. According to an embodiment of the present invention, a handover type may be determined by considering a CA environment introduced to perform the aforementioned three operations.

The D-RRM may prepare candidate CC sets to determine a handover type of FIG. 8 according to a 3GPP NCMA handover policy. To support the handover decision and the handover execution, the UE may perform the following operations:

Specifically, in the information collecting operation, the UE may measure information associated with a radio link quality (L1 DL Meas) for each CC being currently used, a state of UL traffic buffer (L2 Meas) for each CC being currently used, and the like. The UE may report to a current serving base station (eNodeB) about the measurement result using an RRC protocol.

As shown in FIG. 7, an UL/DL non-matching circumstance may exist and thus, L1 of a base station may measure, for each UE, a radio link quality of UL CCs being used by the UE. L1 of the base station may report to L3 of the base station about the measured radio link quality of UL CCs and UL interference information. Hereinafter, the measured parameters will be further described with reference to FIG. 7.

Referring to FIG. 7, it is assumed that the single base station 71 uses CC4, CC5, and CC6 for UL, and uses CC1, CC2, and CC3 for DL, and UE1 uses CC1, CC2, and CC3 for DL and uses CC6 for UL, as indicated by a dotted line, in a state where the UE1 is connected to the base station 71. In the CA environment, in addition to parameter measurement and DL related measurement information, UL related measurement information (e.g., buffer amount measurement, UL radio quality measurement in a base station, interference measurement) measured in the base station (eNodeB) may be required. Specifically, since non-matching with respect to CC up and CC down may occur as shown in FIG. 7, to separately measure and manage UL and DL may be more appropriate for the CA environment.

In FIG. 7, when the single base station 71 uses CC1, CC2, and CC3 for DL, and uses CC4, CC5, and CC6 for UL, and the UE1 connected to the base station 71 is currently using CC1, CC2, and CC3 for DL and is using CC6 for UL, parameters required at the base station 71 for mobility management in a CA cellular environment may be represented by Table 1, Table 2, and Table 3:

TABLE 1

| Parameter | Indication (value) |
|---|---|
| (Parm 1-1) | DLMC_{CC1}, DLMC_{CC2}, DLMC_{CC3} |
| maximum capacity of | |
| DL for each CC | |
| (DLMC: Maximum | |
| Capacity) | |
| (Parm 1-2) | ULMC_{CC4}, ULMC_{CC5}, ULMC_{CC6} |
| maximum capacity of | |
| UL for each CC | |
| (ULMC) | |
| (Parm 1-3) | e.g., policy (pre-defined and semi-statically changeable |
| UL/DL PRB use | information) such as PRB use constraint for each CC, or use |
| policy for each CC | recommendation based on current position of cell for each |
| and/or each position | UE according to FFR policy. |
| according to | |
| interference | |
| coordination policy | |
| (Parm 1-4) | In the case of UE1, ULGQ_{UE1,}DLGQ_{UE1} |
| total quality to be | |
| guaranteed in | |
| corresponding UE, | |
| for each UE. | |
| (Parm 1-5) | In the case of UE1, (refer to dotted line of FIG. 7), |
| sector quality for each | ULCCGQ_{UE1CC6}, |
| CC to satisfy ULGQ | DLCCGQ_{UE1CC1,}DLCCGQ_{UE1CC2}, DLCCGQ_{UE1CC3,} |
| or DLGQ of | Here, ULGQ_{UE1} = ULCCGQ_{UE1CC6,} |
| corresponding UE for | DLGQ_{UE1} = DLCCGQ_{UE1CC1} + DLCCGQ_{UE1CC2} + DLCCGQ_{UE1CC3} |
| each UE | |
| (Parm 1-6) | In the case of UE1, (refer to dotted line of FIG. 7), |
| reference value of | ULCCTH_{UE1CC6}, |
| physical signal | DLCCTH_{UE1CC1}, DLCCTH_{UE1CC2}, DLCCTH_{UE1CC3} |
| quality measured for | |
| each CC to guarantee | |
| DLCCGQ or | |
| ULCCGQ for each | |
| UE and each CC used | |
| by corresponding UE | |
| in current serving | |
| base station (eNodeB) | |
| of UE | |

Measurement values measured by L1 and L2 of the base station may be expressed by the following Table 2:

TABLE 2

| Layer | Parameter | Measurement value |
|---|---|---|
| L2 | (Parm 2-1) | DLCCAC_{CC1}, |
| (N. L2 | available capacity of DL for each | DLCCAC_{CC2}, |
| Meas box | CC (DLCCAC: Available Capacity) | DLCCAC_{CC3} |
| in eNodeB | (Parm 2-2) | ULCCAC_{CC4}, |
| L2 of FIG. | available capacity of UL for each | ULCCAC_{CC5}, |
| 2) | CC (ULCCAC) | ULCCAC_{CC6} |
| | (Parm 2-3) | DLCCBA_{UE1CC1}, |
| | DL traffic buffer amount for each | DLCCBA_{UE1CC2}, |
| | CC being currently used by UE for | DLCCBA_{UE1CC3} |
| | each UE (DLBA: DL Buffer | |
| | Amount) | |
| L1 | (Parm 2-4) | In the case of UE1, |
| (N.UL | UL quality for each CC being | ULCCQ_{UE1CC6} |
| Meas box | currently used by UE for each UE | |
| of eNodeB | (ULCCQ) | |
| L1 of FIG. | (Parm 2-5) | In the case of UE1, |
| 2) | interference level from another base | ULCCIL_{UE1CC6} |
| | station (eNodeB) to resource region | |
| | for each CC used by current UE | |
| | (ULCCIL: UL CC Interference | |
| | Level) | |

Measurement values measured in L1 and L2 of the UE may be expressed by the following Table 3:

TABLE 3

| Layer | Measurement value | |
|---|---|---|
| L2 | (Parm 3-1) | In the case of UE1 (refer to dotted line of |
| (L2 Meas | UL traffic buffer amount for | FIG. 7), |
| box in UE | each CC being currently used | ULCCBA_{UE1CC6} |
| L2 of | by UE, for each UE | |
| FIG. 2) | | |
| L1 | (Parm 3-2) | In the case of UE1 (refer to dotted line of |
| (DL Meas | DL quality for each base | FIG. 7), when serving eNodeB is eNodeB1, |
| box in UE | station & CC being currently | and neighboring base stations eNodeB2 and |
| L1 of | measured by UE | eNodeB3 exist,) |
| FIG. 2) | (DLENODEBCCSNR) | DLENODEBCCSNR_{UE1CC1eNodeB1,} |
| | D-RRM of serving | DLENODEBCCSNR_{UE1CC2eNodeB1,} |
| | base station may | DLENODEBCCSNR_{UE1CC3eNodeB1} |
| | control target base | DLENODEBCCSNR_{UE1CC1eNodeB2,} |
| | station to be measured | DLENODEBCCSNR_{UE1CC2eNodeB2,} |
| | by UE to be | DLENODEBCCSNR_{UE1CC3eNodeB2} |
| | constrained. | DLENODEBCCSNR_{UE1CC1eNodeB3,} |
| | Serving base station | DLENODEBCCSNR_{UE1CC2eNodeB3,} |
| | may control the UE | DLENODEBCCSNR_{UE1CC3eNodeB3} |
| | periodical report about | |
| | DLENODEBCCSNR | |
| | and/or event report to | |
| | be performed. | |
| | interference level for each CC | In the case of UE 1, |
| | from another base station | DLCCIL_{UE1CC1}, DLCCIL_{UE1CC2}, DLCCIL_{UE1CC3} |
| | (eNodeB) to resource region | |
| | used by corresponding UE, for | |
| | each UE (DLCCIL, DL CC | |
| | Interference Level) | |

In Table 3, each of a UL buffer amount and a DL interference level may be classified into good, average, and poor, and thereby be operated. Consequently, for the mobility management in the CA environment, the D-RRM may perform management and update of semi-static information as shown in Table 1, and may obtain information measured through CSAP in the base station of the D-RRM as shown in Table 2, and information measured by the UE as shown in Table 3 through RRC. Specifically, the D-RRM may perform the mobility management in the CA environment, based on the above information as shown in Table 1, Table 2, and Table 3.

In general, a handover in the CA environment may occur in the following three cases:

Specifically, in a first case where SNR quality of currently connected CCs is deteriorated, in a second case where interference is relieved in a system aspect, and in a third case where a load distribution of a system level is required based on a traffic situation, the handover may occur.

According to an embodiment of the present invention, an example where the first case is handled by CMC of the D-RRM, the second case is handled by ICC, and the third case is handled by TLC will be described.

Initially, the second case where the interference is relieved in the system aspect will be further described.

When an ICC function is included in the D-RRM, ICC may perform interference control by means of UL/DL Physical Resource Block (PRB) use policy and proactive approach for each CC according to the interference coordination policy described above with Table 1. The interference control may be referred to as interference indication. The proactive approach indicates preventively controlling of interference according to a pre-defined interference standard.

ICC may perform the interference control using reaction approach based on a measurement result of an interference level (ULCCIL, DLCCIL) for each CC used by a corresponding UE, which is described above with reference to Table 2 and Table 3. Information received by CMC from ICC according to the interference control of ICC is defined herein as interference indication. The reaction approach indicates that interference is later controlled based on an interference occurrence result.

In a proactive aspect, the interference indication may indicate refraining or recommending use of a particular PRB resource in CC used by the corresponding UE since the interference is controlled, or may indicate forbidding use of corresponding CC or using of the corresponding CC.

In a reactive aspect, the interference indication may indicate requesting of a reaction based on an interference level occurring in CC used by the corresponding UE. For example, the interference level “good” corresponds to a case where a relatively large amount of interference exists in PRB being used in corresponding CC used by the UE. Accordingly, as a reaction, it is possible to move to another PRB in the same CC, or to move from current CC to another CC.

Specifically, the embodiment is based on the CA environment and thus, an operation of moving from current PRB to another PRB in the same CC may be performed by means of a MAC scheduler. Accordingly, the aforementioned interference indication of ICC may be interpreted as a meaning of controlling the corresponding UE to not use corresponding CC due to an interference issue. CMC of the D-RRM recognizing the above interference indication may not use the corresponding CC.

Hereinafter, the third case where the load distribution of the system level is required based on the traffic situation will be further described.

When a TLC function is included in the D-RRM, TLC may perform overload indication control by considering or referring to the aforementioned information with reference to Table 1, Table 2, and Table 3. For example, in the aforementioned information, the maximum capacity of DL and UL for each CC (DLMC (Parm 1-1), ULMC (Parm 1-2)) and quality ((Parm 1-4), (Parm 1-5)) may be considered. Also, the available capacity of UL and DL (DLCCAC (Parm 2-1), ULCCAC (Parm 2-2)), the traffic buffer amount of UL and DL (DLCCBA (Parm 2-3), ULCCBA (Parm 3-1)) may be referred to.

The overload indication control indicates that TLC informs, based on the aforementioned information, CMC to constrain random UE using random CC. When the determined overload indication is received from TLC, and when the corresponding UE is using the corresponding CC, CMC may perform a most appropriate type of handover without using the corresponding CC.

[Handover Type Decision of FIG. 8]

Hereinafter, a method of determining, by the D-RRM of the current base station of FIG. 3, a handover type of FIG. 8 based on the parameters defined in Table 1, Table 2, and Table 3 will be described.

One of the greatest changes in the handover in the CA environment may include that Intra-eNodeB HO may occur, and that UL handover and DL handover of Intra-eNodeB HO may separately occur in independent time. Intra-eNodeB HO corresponds to a handover where CC is changed in the same base station.

In the case of Inter-eNodeB HO, UL handover and DL handover may need to be simultaneously performed. Inter-eNodeB HO may consider only DLENODEBCCSNR quality (Parm 3-2 of Table 3) which is similar to an existing handover, and may also consider ULCCQ quality (Parm 2-4 of Table 2) and DLENODEBCCSNR. Specifically, when a Best CC set (BCcc) is determined in one link (e.g., DL), and when the determined BCcc set indicates Inter-eNodeB HO, BCcc of another link (e.g., UL) may also be determined from CCs of a target base station. In a state where both UL BCcc and DL BCcc with respect to the target base station are secured, Inter-eNodeB HO needs to be performed. This is because BCcc corresponds to a CC set of the target eNodeB. BCcc indicates a CC set determined to be most appropriate for a UE, which is being currently serviced in a serving base station.

When comparing UL (UCcc) and DL (UCcc) in a current serving base station with UL (BCcc) and DL (BCcc) determined by the serving base station, a DL based handover type of FIG. 8 may be similarly applicable to UL. Even though DL shows the type shown in the diagram 811 or 812, it cannot be said that the handover shown in the diagram 811 or 812 simultaneously occurs in UL.

When comparing UL (UCcc) and DL (UCcc) in the current serving base station with UL (BCcc) and DL (BCcc) determined by the serving base station, a comparison result may be Inter-eNodeB HO. In this case, UL only HO, DL only HO, or UL/DL simultaneous HO may occur, which may be a union type or a split type.

Also, when comparing UL (UCcc) and DL (UCcc) in the current serving base station with UL (BCcc) and DL (BCcc) determined by the serving base station, a comparison result may be Inter-eNodeB HO. In this case, UL/DL simultaneous HO may be performed. Also, Inter-eNodeB CC Breakup HO of the diagram 822 may occur in DL, and Inter-eNodeB Intra-CC Batch HO of the diagram 821 may occur in UL, which may be a union type or a split type.

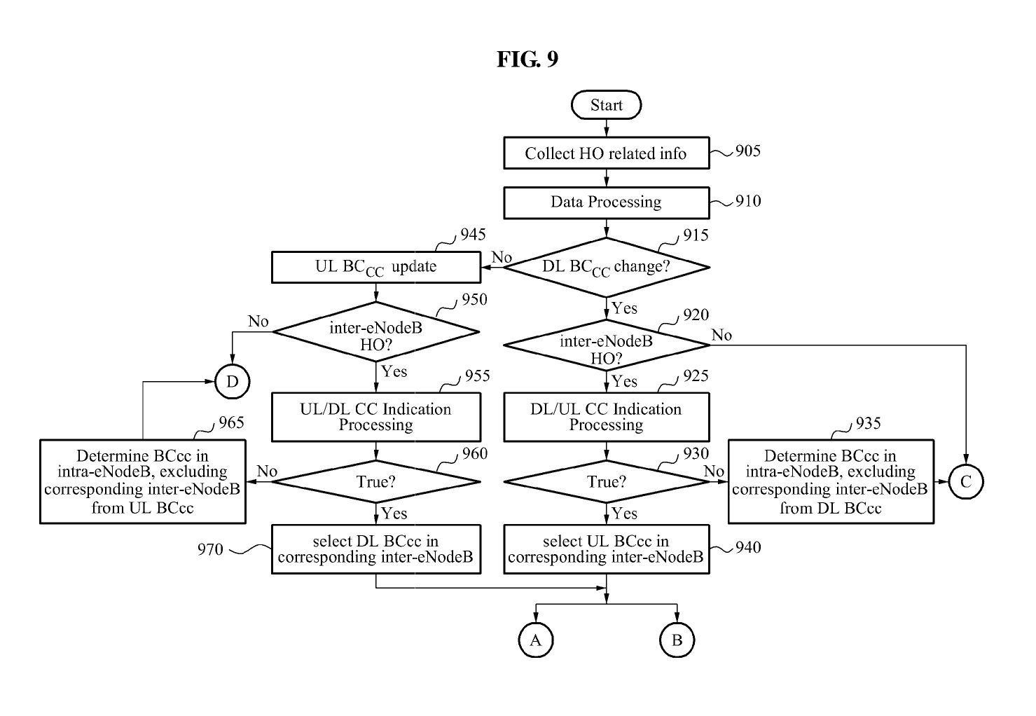

Similarly, in the case of Inter-eNodeB HO, UL and DL simultaneously HO may need to be performed with respect to the target eNodeB. However, their types may be the same as each other or be different from each other. A procedure of determining the above type will be described with reference to FIG. 9 through FIG. 11.

When handover execution is performed after handover decision, a serving base station may transmit, to a UE, an RRCConnectionReconfiguration (for HO) message. The serving base station may integrally provide information associated with PHY/MAC/RLC/PDCP required to use the determined UL and/or DL BCcc and connection relationship between mutual entities.

When the transmitted RRCConnectionReconfiguration message includes an Intra-eNodeB HO command, the serving base station may continuously maintain a status of the serving base station, and the UE may transmit, to the serving base station, an RRCConnectionReconfigurationComplete message that is a response message to the RRCConnectionReconfiguration message.

Also, when the transmitted RRCConnectionReconfiguration message includes an Inter-eNodeB HO command, the serving base station may lose the status of the serving base station and become a neighboring base station. The UE may transmit, to the corresponding neighboring base station, an RRCConnectionReconfigurationComplete message that is a response message to the RRCConnectionReconfiguration message.

Referring again to FIG. 8 from viewpoint of BCcc and UCcc, when BCcc determined on a UL or DL side is the same as UCcc, the handover may occur.

Also, when BCcc to be determined on the UL or DL side is determined in CC within a source base station, and when the determined BCcc is different from UCcc, Intra-eNodeB HO may occur. However, when only a UL case is different, UL only Intra-eNodeB HO may occur. When only a DL case is different, DL only Intra-eNodeB HO may occur.

When the determined UL or DL BCcc is CC of a neighboring base station, a handshake message exchange with the neighboring base station may be required. Parm 4-2-3 determined through the above exchange may be determined as finally cooperated BCcc. The handshake message exchange may correspond to a process of transmitting, by the serving base station, a handover request message (4-1) of Table 4 to the neighboring base station, and transmitting, by the neighboring base station as a response, a handover request acknowledgment (ACK) message (4-2) of Table 4 to the serving eNodeB. A process of determining, by the neighboring base station, Parm 4-2-3 will be omitted.

TABLE 4

| | | |
|---|---|---|
| Handover | (Parm 4-1-1) | UE1 ID |
| Request | UE ID (information capable of | |
| (4-1) | identifying corresponding UE, | |
| | which can be provided in any type) | |
| | (Parm 4-1-2) | eNodeB 1 {ULGQ_{UE1} = 30, |
| | serving eNodeB ID {Table 1's | DLGQ_{UE1} = 40} |
| | (Parm 1-4) ULGQ, DLGQ} | |
| | (Parm 4-1-3) | eNodeB 1 {DLCCGQ_{CC1} = 13, |
| | serving eNodeB ID {Table 1's | DLCCGQ_{CC2} = 12, DLCCGQ_{CC3} = |
| | (Parm 1-5)ULCCGQ, DLCCGQ} | 15, ULCCGQ_{CC6} = 30} |
| | (Parm 4-1-4) | eNodeB 2 {CC2, CC3} |
| | In (Parm 3-2) of Table 3, | |
| | CC set with respect to | |
| | corresponding base stations to | |
| | transmit handover request among | |
| | neighboring base stations having, as | |
| | a condition, DLENODEBCCSNR | |
| | greater than T_{PREP,} | |
| | neighboring eNodeB ID to transmit | |
| | handover request{DL-CC set} | |
| | (Parm 4-1-5) | eNodeB 1 |
| | serving eNodeB ID {used CC set} | {DL(CC1, CC2, CC3), |
| | (information that can be | UL(CC6)} |
| | estimated through Parm 4- | |
| | 1-3, which is added for | |
| | convenience of description) | |
| | (Parm 4-1-6) | eNodeB 1 {DL(CC2, CC3), |
| | serving eNodeB ID {Full coverage | UL(CC5, CC6)} |
| | DL CC set} | |
| | (Parm 4-1-7) | UEDLCapa(3) |
| | maximum number of CCs | UEULCapa(3)) |
| | supportable in UE1 | |
| | UEDLCapa, UEULCapa | |
| Handover | (Parm 4-2-1) | UE1 ID |
| Request ACK | UE ID (information capable of | |
| (4-2) | identifying corresponding UE, | |
| | which can be provided in any type) | |
| | (Parm 4-2-2) | Success |
| | Success or Failure | |
| | only in case of success (Parm 4-5, | |
| | 4-6, 4-7 corresponds to valid | |
| | information) | |
| | (Parm 4-2-3) | eNodeB 2 {DL(CC3), |
| | neighboring eNodeB ID {available | UL(CC5)} |
| | DL-CC set, UL-CC set} | — |
| | (Parm 4-2-4) | eNodeB 2 {ULGQ_{UE1}, |
| | neighboring eNodeB ID {Table 1's | DLGQ_{UE1}} |
| | (Parm 1-4) ULGQ, DLGQ} | |
| | (Parm 4-2-5) | eNodeB 2 {DLCCGQ_{CC3}, |
| | neighboring eNodeB ID {Table 1's | ULCCGQ_{CC5}} |
| | (Parm 1-5)ULCCGQ, DLCCGQ} | |

Hereinafter, cases of a handover type based on a variety of situations will be described.

serving base station UCcc

UE1 UL UCcc=eNodeB1 {CC6}

UE1 DL UCcc=eNodeB1 {CC1, CC2, CC3}

Case 1

UE1 UL UCcc=eNodeB 1 {CC6}

UE1 DL UCcc=eNodeB1 {CC1, CC2, CC3}

Case 2

UE1 UL BCcc=eNodeB1 {CC6}

UE1 DL BCcc=eNodeB1 {CC2, CC3}

Case 3

UE1 UL BCcc=eNodeB1 {CC5}

UE1 DL BCcc=eNodeB1 {CC1, CC2, CC3}

Case 4

UE1 UL BCcc=eNodeB2 {CC5}

UE1 DL BCcc=eNodeB1 {CC2,CC3}

Case 4-1

UE1 UL BCcc=eNodeB2 {CC5}

UE1 DL BCcc=eNodeB2 {CC1,CC3}

[UCcc AND Case 1. BCcc]

[symbol] HO does not occur.

[UCcc AND Case 2. BCcc]

[symbol] Only [DL HO Execution] occurs, and a handover type corresponds to Intra-eNodeB CC Less Split Breakup HO.

[UCcc AND Case 3. BCcc]

[symbol] Only [UL HO Execution] occurs, and a handover type corresponds to Intra-eNodeB CC Batch HO.

[UCcc AND Case 4. BCcc]

[symbol] In Case 4, it can be recognized that inter-eNodeB exists in UL BCcc.

[symbol] Transmits the handover request message (4-1) of Table 4 to eNodeB 2 (Parm 4-1-4 corresponds to only DL case. Here, CC of DLENODEBCCSNR of eNodeB 2 over (Parm 1-6) DLCCTH of Table 1 may be input in a descending order). If (Parm 4-2-2) of the handover request ACK message (4-2) of Table 4 in response to the above message is a success, (Parm 4-2-3) is updated with BCcc.

[symbol] When BCcc received as a response corresponds to Case 4-1, [DL HO Execution] and [UL HO Execution] may need to be processed into a single message and thereby simultaneously be processed. The former (DL) corresponds to Inter-eNodeB CC Less Split Breakup HO, and the latter (UL) corresponds to Inter-eNodeB Inter-CC Batch HO.

[Data Processing]

Data processing used for HO decision corresponds to a process of receiving handover related information through RRC, X2AP, and CSAP in the framework of FIG. 2, and processing data for the HO decision based on the received handover related information. Data processing may be generally categorized into radio condition related processing, traffic load related processing, and interference related processing. According to an embodiment of the present invention, the categories may be handled by corresponding logical entities, i.e., CMC, TLC, and ICC. In the case of the second category and the third category, an effect of TLC and ICC with respect to CMC will be described.

[Data Processing-Radio Condition Related Processing as a CMC Function]

In FIG. 7, data processing from viewpoint of CMC corresponds to a portion of receiving handover related information through RRC, X2AP, and CSAP in the framework of FIG. 2 to determine a handover based on the received handover related information.

A group of CC sets being currently used may be generally managed based on two types. One type is defined as CC set (UCcc) of a serving base station being currently used by UE, and may be managed with respect to UL and DL. Another type is defined as BCcc. With respect to each of the serving base station and neighboring base station, radio condition may be measured in UL and DL. A CC set (Measured CC (MCcc) based on the measured radio condition may be prepared. Here, CC having a best condition to be used in the MCcc is defined as BCcc.

[UCcc]

UE1−DL UCcc=eNodeB1 {CC1, CC2}

UE1−UL UCcc=eNodeB1 {CC6}

Indicates that UE1 is using CC6 of eNodeB1 for UL, and is using CC1 and CC2 for DL.

[MCcc]

UE1−DL MCcc=eNodeB1 {CC1,CC2,CC3}

UE1−DL MCcc=eNodeB2 {CC1,CC2,CC3}

UE1−UL MCcc=eNodeB1 {CC4,CC5,CC6}

A D-RRM of a serving base station (eNodeB 1) may control a measurement target for each CC. For example, through measurement control, the serving base station (eNodeB 1) may instruct UE1 to measure DLENODEBCCSNR (Parm 3-2) with respect to DL CC1, CC2, and CC3 of the serving base station (eNodeB 1), and with respect to DL CC1, CC2, and CC3 of a neighboring base station (eNodeB 2).

Also, the serving base station (eNodeB 1) may instruct L1 of the serving base station (eNodeB 1) to measure ULCCQ (Parm 2-4) with respect to UL CC4, CC5, and CC6 of the serving base station (eNodeB 1) being currently used by UE1.

For each CC, a DLENODEBCCSNR measurement value with respect to DL and UL CCQ measurement value with respect to UL may be obtained from MCcc determined through the measurement control.

[BCcc]

In the case of DL, if DLENODEBCCSNR with respect to each CC member of UCcc is greater than ‘DLCCTH (Parm 1-6)+DLCCTHMargin’, DL UCcc=DL BCcc.

In the case of UL, if ULCCQ with respect to each CC member of UCcc is greater than ‘ULCCTH (Parm 1-6)+ULCCTHMargin’, UL UCcc=UL BCcc.

Here, a margin (DLCCTHMargin, ULCCTHMargin) value in a system operation may be applicable to DLCCTH and ULCCTH.

In the case of DL, if DLENODEBCCSNR with respect to each CC member of UCcc becomes to be less than ‘DLCCTH (Parm 1-6)+DLCCTHMargin’, DL BCcc may be calculated as follows:

A. Algorithm DL BCcc Determining Process:

a.1 If ((DLENODEBCCSNR of CC member of DL UCcc of serving eNodeB) <
(DLCCTH+ DLCCTHMargin))
then
{

a.1.1 calculates a sum of differences with respect to CCs of DL MCcc of which

DLENODEBSNR is over ‘DLCCTH’.

a.1.2 determines, as BCcc, a greatest value among values obtained in a.1.1.
a.1.3 if(BCcc = intra-eNodeB)
{

a.1.3.1 By means of a TLC function, members greater than (DLCCTH+

DLCCTHMargin) among serving eNodeB DL MCcc members assigned in a
descending order based on DLGQ (Farm 1-4) and DLCCAC (Parm 2-1).

a.1.3.2 If the assignment is a success, the assignment is determined as BCcc,

and if the assignment a failure, e a second value obtained in a.1.1 is determined as
BCcc. Since it is inter-eNodeB, it goes to a processing route within a.1.4.

}
a.1.4 else //if (BCcc = inter-eNodeB)
{

a.1.4-1 Transmits 4-1 message of Table 4 to neighboring eNodeB.
a.1.4-2 Receives 4-2 message of Table 4. If (Parm 4-2-2) of 4-2 of Table 2 is a

success, (Parm 4-2-3) is determined as BCcc.

a.1.4-3 If (Parm 4-2-2) of 4-2 of Table 4 is a failure, a next greatest value of a

value obtained in a.1.1 is determined as BCcc, and a.1.4 is repeated until eNodeB
corresponding to a.1.1 exists.

}

}

Describing a.1.1,

if DLCCTH is the same as 7 for each CC and DL UCcc = {CC1, CC2, CC3},

UE1-DL MCcc = eNodeB1{CC1,CC2,CC3} →

DLENODEBCCSNR{5,18,13} → (18−7)+(13−7)= 17

UE1-DL MCcc = eNodeB2{CC1,CC2,CC3} → DLENODEBCCSNR{3, 2,

8} → (8−7) = 1

goes to a.1.3 (intra-eNodeB) and thereby is processed.

if DLCCTH is the same as 7 for each CC and DL UCcc = {CC1, CC2, CC3},

UE1-DL MCcc = eNodeB1{CC1,CC2,CC3} →

DLENODEBCCSNR{8,8,8} → (8−7)+(8−7)+(8−7)= 3

UE1-DL MCcc = eNodeB2{CC1,CC2,CC3} →

DLENODEBCCSNR{9,10,11} → (9−7)+(10−7)+(11−7)= 9

goes to a.1.4 (inter-eNodeB) and thereby is processed.

In a.1.4, a handshake process with a neighboring base station using 4-1 and 4-2 that are X2AP messages may be sequentially performed, or may be performed in parallel with a neighboring base station satisfying a condition of a.1.1, or may be performed in a case where a DLENODEBCCSNR value exceeds a predetermined reference value. When using X2AP, DL BCcc may need to be transferred through (Parm 4-2-3).

In the case of UL, if ULCCQ with respect to each CC member of UCcc becomes to be less than ‘ULCCTH (Parm 1-6)+ULCCTHMargin’, UL BCcc may be calculated as follows:

B. Algorithm UL BCcc Determining Process:

b.1 If ((ULCCQ CC member of UL UCcc of serving eNodeB) < (ULCCTH+
ULCCTHMargin))
then
{

b.1.1 calculates a sum of differences with respect to CCs of DL MCcc of which

ULCCQ is over ‘ULCCTH’.

b.1.2 determines, as BCcc, a greatest value among values obtained in b.1.1.
b.1.3

b.1.3.1 By means of a TLC function, members greater than (ULCCTH+

ULCCTHMargin) among serving eNodeB UL MCcc members assigned in a
descending order based on ULGQ (Farm 1-4) and ULCCAC(Parm 2-1) .

```
  b.1.3.2 if(assignment is a success)
  {
```

determines the assignment as BCcc

}
b.1.3.3 else //(assignment is a failure)
{

b.1.3.3-1 transmits 4-1 message of Table 4 to neighboring eNodeB in a

descending order excluding Intra-eNodeB among values obtained in a.1.1.

b.1.3.3-2 receives 4-2 message of Table 4. If Parm 4-2-2 of Table 4 is a

success, determines (Parm 4-2-3) as BCcc.

b.1.3.3-3 If (Parm 4-2-2) of 4-2 of Table 4 is a failure, determines, as BCcc, a

```
  next greatest value among values obtained in a.1.1, and repeats b1.3.3 until
  eNodeB satisfying a.1.1 exists.
```

}

Describing a.1.1 as an embodiment,

if ULCCTH is the same as 7 for each CC and UL UCcc = {CC6},

UE1-UL MCcc = eNodeB1{CC4,CC5,CC6} →

DLENODEBCCSNR{18,12,5} → b.1 condition

[Data Processing—Traffic Load Related Processing as a TLC Function]

TLC of D-RRM present in a single base station may forbid or recommend using of CCs of the base station of the TLC. TLC of the D-RRM may transmit and receive a handshake message or an instruction to and from TLC of a neighboring base station through an X2AP interface, and thereby forbid or recommend using of CC in a traffic load balancing level. It is defined herein as Traffic Load Indication (TLI), which indicates constraining using of CC with respect to a particular UE within the base station of the TLC of the D-RRM. According to the above definition, corresponding CC may need to be excluded from a.1.1 and a.1.3.1 of A algorithm and b.1.1, and b.1.3.1 of B algorithm.

[Data Processing—Interference Coordination Related Processing as an ICC Function]

ICC of D-RRM present in a single base station may forbid or recommend using of CCs of the base station of the ICC.

ICC of D-RRM may transmit and receive a handshake message or an instruction to and from ICC of D-RRM of a neighboring base station through an X2AP interface, and thereby may forbid or recommend its D-RRM CMC from or for using of CC in an interference coordination level.

It is defined herein as Interference Coordination Indication (ICI), which indicates constraining using of CC with respect to a particular UE within the base station of the ICC of the D-RRM. According to the above definition, corresponding CC may need to be excluded from a.1.1 and a.1.3.1 of A algorithm and b.1.1, and b.1.3.1 of B algorithm.

Hereinafter, a process of determining a handover type will be described with reference to FIG. 9 through FIG. 12. An Inter-eNodeB HO type determined by FIG. 9 through FIG. 12 is indicated together with DL or UL.

FIG. 9 is a flowchart illustrating a method of determining CC to be used for a handover based on a DLENODEBCCSNR measurement value according to an embodiment of the present invention.

In operation 905, a serving base station may collect measurement information through RRC, CSAP, and X2AP.

In operation 910, CMC of D-RRM of the serving base station may perform the aforementioned data processing. As described above, the data processing may include radio condition processing, traffic/load processing, and interference processing.

When BCcc of DL is changed as a result of the data processing in operation 915, the serving base station may determine whether the changed BCcc is included in a CC set of the serving base station in operation 920. Specifically, in operation 920, the serving base station may determine whether HO occurring due to use of the changed BCcc corresponds to inter-eNodeB HO. The inter-eNodeB HO corresponds to HO occurring between base stations.

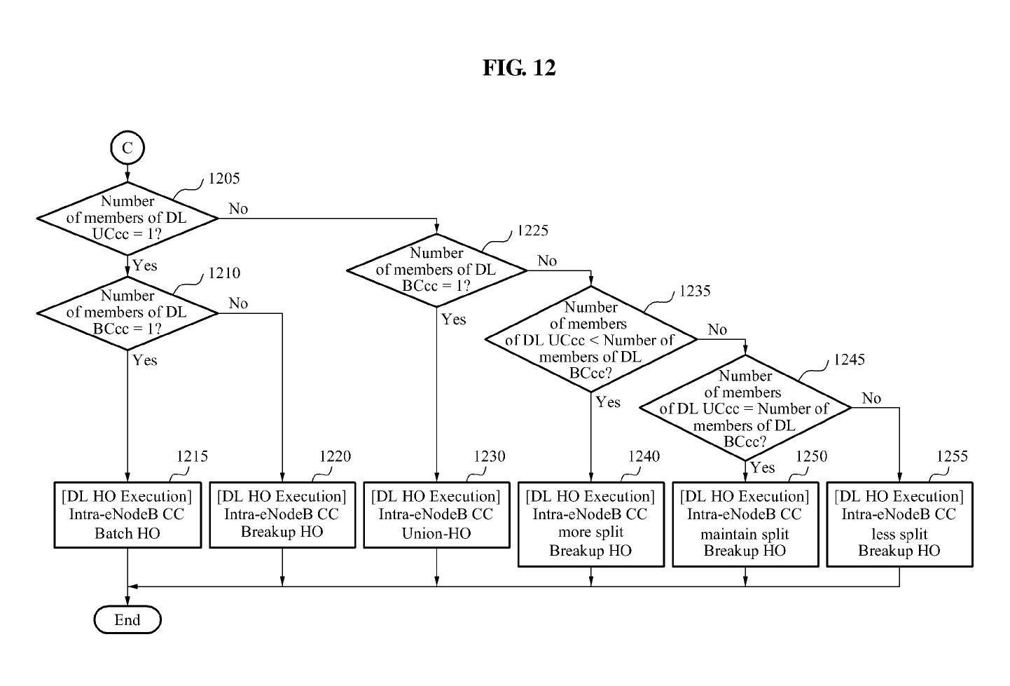

When the changed BCcc is included in the CC set of the serving base station, that is, when the HO does not correspond to the inter-eNodeB HO, the serving base station may perform a process C of FIG. 12.

When the changed BCcc corresponds to a target base station (e.g., eNodeB 2) as a determination result of operation 920, that is, when the HO corresponds to the inter-eNodeB HO, the serving base station may perform DL/UL CC indication processing in operation 925. The DL/UL CC indication processing indicates that whether to perform inter-eNodeB HO from DL viewpoint is considered together with UL.

If DL/UL CC indication is false in operation 930, the serving base station may exclude CC of the target base station (eNodeB 2) from DL BCcc, and may determine BCcc in intra-eNodeB corresponding to a subsequent priority, that is, in CC of the serving base station (eNodeB 1) in operation 935.

Conversely, if DL/UL CC indication is s true in operation 930, the serving base station may determine UL BCcc among CCs of the target base station (eNodeB 2) in operation 940. Here, a handover type may be determined by means of comparison with respect to a number of members of UCcc, a number of members of BCcc, and CC. Accordingly, a UL handover type and a DL handover type may be the same or different.

When BCcc of UL is changed as a result of the data processing in operation 945, the serving base station may determine whether the changed BCcc is included in the CC set of the serving base station in operation 950. Specifically, in operation 950, the serving base station may determine whether HO occurring due to use of the changed BCcc corresponds to inter-eNodeB HO.

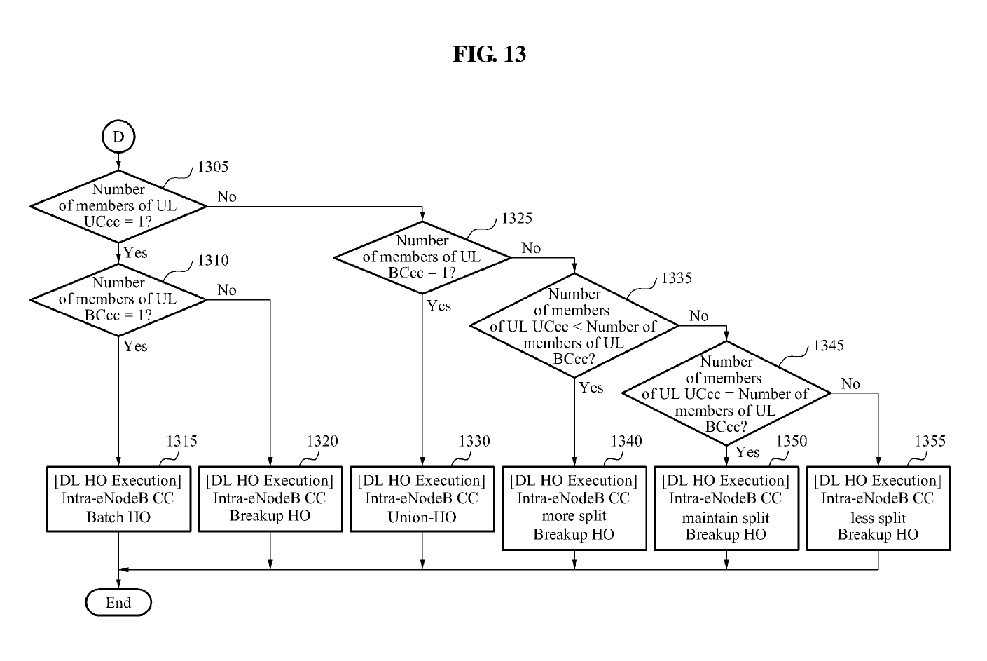

When the changed BCcc is included in the CC set of the serving base station, that is, when the HO does not correspond to the inter-eNodeB HO, the serving eNodeB may perform a process D of FIG. 13.

When the changed BCcc corresponds to the target base station (e.g., eNodeB 2) as a determination result of operation 950, that is, when the HO corresponds to the inter-eNodeB HO, the serving base station may perform UL/DL CC indication processing in operation 955. The UL/DL CC indication processing indicates that whether to perform inter-eNodeB handover in a UL aspect is considered together with DL.

If UL/DL CC indication is false in operation 960, the serving base station may exclude CC of the target base station (eNodeB 2) from UL BCcc, and may determine BCcc in intra-eNodeB corresponding to a subsequent priority, that is, CC of the serving base station (eNodeB 1) in operation 965.

Conversely, if UL/DL CC indication is true in operation 960, the serving base station may determine DL BCcc among CCs of the target base station (eNodeB 2) in operation 970. Here, a handover type may be determined by means of comparison with respect to a number of members of UCcc, a number of members of BCcc, and CC. Accordingly, a UL handover type and a DL handover type may be the same or different.

As described above with reference to FIG. 9, when DL BCcc is changed and the changed DL BCcc indicates inter-eNodeB HO, DL/UL HO Execution may need to be performed at the same point in time by changing UL BCcc to CC of the target base station (eNodeB 2).

When UL BCcc is changed and the changed UL BCcc indicates inter-eNodeB HO, UL/DL HO Execution may need to be performed at the same point in time by changing DL BCcc to CC of the target base station (eNodeB 2). Here, in the case of inter-eNodeB HO, DL HO and UL HO may be simultaneously performed, however, the DL HO type and the UL HO type may be different.

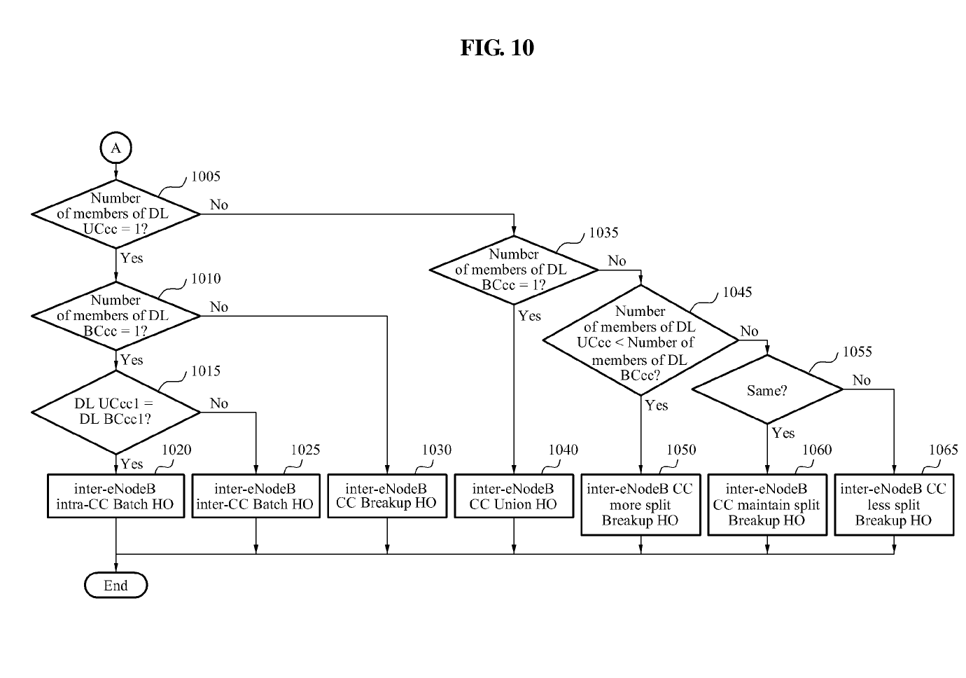

FIG. 10 is a flowchart to describe a process of determining a type of DL CA handover according to change of DL BCcc in inter-eNodeB HO according to an embodiment of the present invention.

In operation 1005, a serving base station may verify a number of members of DL UCcc being used by a UE. When the number of members of DL UCcc=1, the serving base station may verify whether a number of members of changed DL BCcc=1 in operation 1010.

In operation 1015, the serving base station may determine whether DL UCcc is the same as DL BCcc. Specifically, the serving base station may determine whether a frequency band being currently used in a downlink is matched with a candidate frequency band to be used for handover. When the frequency band is matched with the candidate frequency band, the serving base station may determine a handover type as inter-eNodeB intra-CC Batch HO in operation 1020, which is described above with reference to the diagram 821 of FIG. 8.

Conversely, when DL UCcc is different from DL BCcc in operation 1015, the serving base station may determine the handover type as inter-eNodeB inter-CC Batch HO in operation 1025, which is described above with reference to the diagram 821 of FIG. 8.

When the number of members of DL BCcc≠1 in operation 1010, the serving base station may determine the handover type as inter-eNodeB CC Breakup HO in operation 1030, which is described above with reference to the diagram 822 of FIG. 8.

When the number of members of DL UCcc≠1 in operation 1005, the serving base station may verify whether the number of members of DL BCcc=1 in operation 1035.

When the number of members of DL BCcc=1, the serving base station may determine the handover type as inter-eNodeB CC Union HO in operation 1040, which is described above with reference to the diagram 822 of FIG. 8.

When the number of members of DL BCcc≠1 in operation 1035, the serving base station may compare the number of members of DL UCcc with the number of members of DL BCcc in operation 1045.

When the number of members of DL BCcc is greater than the number of members of DL UCcc in operation 1045, the serving base station may determine the handover type as inter-eNodeB CC more split Breakup HO in operation 1050, which is described above with reference to the diagram 831 of FIG. 8.

When the number of members of DL UCcc is the same as the number of members of DL BCcc in operation 1055, the serving base station may determine the handover type as inter-eNodeB CC maintain split Breakup HO in operation 1060, which is described above with reference to the diagram 831 of FIG. 8.

When the number of members of DL UCcc is not the same as the number of members of DL BCcc in operation 1055, that is, when the number of members of DL UCcc is greater than the number of members of DL BCcc in operation 1055, the serving base station may determine the handover type as inter-eNodeB CC less split Breakup HO in operation 1065, which is described above with reference to the diagram 831 of FIG. 8.

FIG. 10 illustrates a process of determining a type of inter-eNodeB HO according to the change of DL BCcc in inter-eNodeB HO. When DL BCcc is changed, and when the HO corresponds to inter-eNodeB HO, a handover type may be determined by means of comparison with respect to a number of CC members within DL UCcc, a number of CC members within DL BCcc, and CC. DL inter-eNodeB HO Execution may be performed without a direct relation to UL.

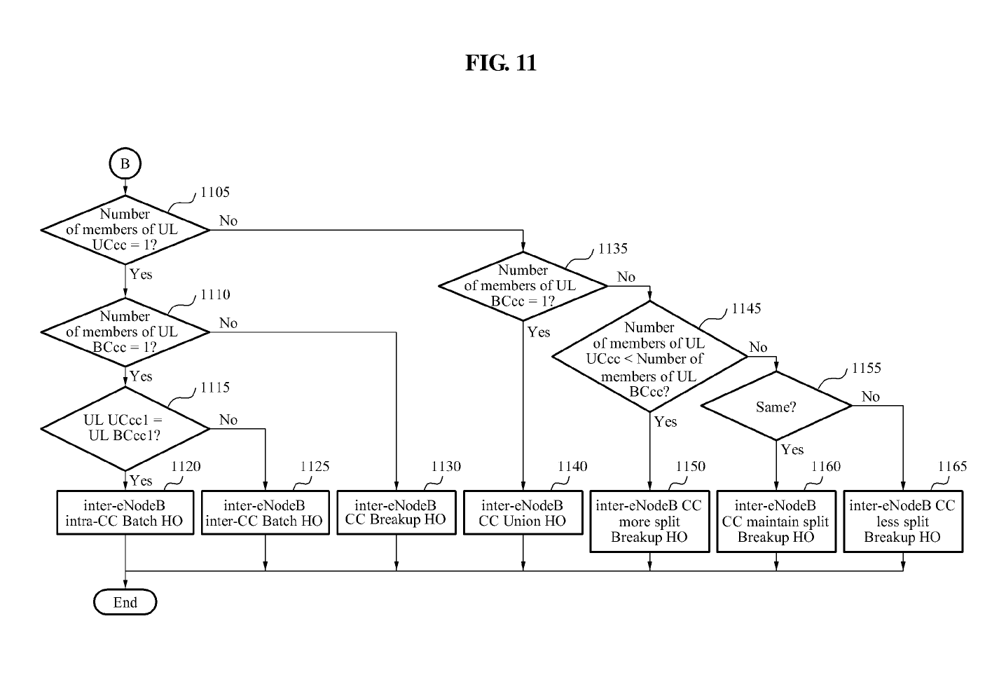

FIG. 11 is a flowchart to describe a process of determining a type of UL CA handover according to change of UL BCcc when inter-eNodeB HO is performed according to an embodiment of the present invention.

Operations 1105 through 1165 of FIG. 11 are similar to operation 1005 through 1065 of FIG. 10 and thus, further descriptions will be omitted here. In the case of inter-eNodeB HO described with reference to FIG. 10 and FIG. 11, a handover type may be differently determined with respect to UL and DL. However, the handover may be simultaneously performed with respect to UL and DL.

FIG. 12 is a flowchart to describe a process of determining a type of DL CA handover according to change of DL BCcc when intra-eNodeB HO is performed according to an embodiment of the present invention.

In operation 1205, a serving base station may verify a number of members of DL UCcc being used by a UE. When the number of members=1, the serving base station may verify whether a number of members of DL BCcc, changed in operation 915 of FIG. 9,=1 in operation 1210.

When the number of members of DL BCcc=1, the serving base station may determine a handover type as intra-eNodeB CC Batch HO in operation 1215, which is described above with reference to the diagram 811 of FIG. 8.

When the number of members of DL BCcc≠1 in operation 1210, the serving base station may determine the handover type as intra-eNodeB CC Breakup HO in operation 1220, which is described above with reference to the diagram 812 of FIG. 8.

When the number of members of DL UCcc≠1 in operation 1205, the serving base station may verify whether the number of members of DL BCcc=1 in operation 1225.

When the number of members of DL BCcc=1, the serving base station may determine the handover type as intra-eNodeB CC Union HO in operation 1230, which is described above with reference to the diagram 812 of FIG. 8.

When the number of members of DL BCcc≠1 in operation 1225, the serving base station may compare the number of members of DL UCcc with the number of DL BCcc in operation 1235.

When the number of members of DL BCcc is greater than the number of members of DL UCcc in operation 1235, the serving base station may determine the handover type as inter-eNodeB CC more split Breakup HO in operation 1240, which is described above with reference to the diagram 831 of FIG. 8.

When the number of members of DL UCcc is the same as the number of members of DL BCcc in operation 1245, the serving base station may determine the handover type as inter-eNodeB CC maintain split Breakup HO in operation 1250, which is described above with reference to the diagram 831 of FIG. 8.

When the number of members of DL UCcc is not the same as the number of members of DL BCcc in operation 1245, that is, when the number of members of DL UCcc is greater than the number of members of DL BCcc, the serving base station may determine the handover type as inter-eNodeB CC less split Breakup HO in operation 1255, which is described above with reference to the diagram 831 of FIG. 8.

FIG. 12 illustrates a process of determining a type of intra-eNodeB HO according to change of DL BCcc in intra-eNodeB HO. When DL BCcc is changed, and when corresponding HO corresponds to intra-eNodeB HO, a handover type may be determined by means of comparison with respect to a number of CC members within DL UCcc, a number of CC members within DL BCcc, and CC. DL intra-eNodeB HO Execution may be performed without a direct relation to UL.

FIG. 13 is a flowchart to describe a process of determining a type of UL CA handover according to change of UL BCcc change when intra-eNodeB HO is performed according to an embodiment of the present invention.

Operations 1305 through 1355 of FIG. 13 are similar to operations 1205 through 1255 of FIG. 12 and thus, further descriptions will be omitted here. When UL BCcc is changed, and when a corresponding HO corresponds to intra-eNodeB HO, the handover type may be determined by means of comparison with respect to a number of CC members within UL UCcc, a number of CC members within UL BCcc, and CC. UL intra-eNodeB HO Execution may be performed without a direct relation to DL.

[UL/DL CC Indication Processing or DL/UL CC Indication Processing of FIG. 9]

Hereinafter, DL/UL CC indication processing performed in operation 925 of FIG. 9 and UL/DL CC indication processing performed in operation 955 will be described.

When DL BCcc is determined as inter-eNodeB, the serving base station may perform DL/UL CC indication processing. When UL BCcc is determined as inter-eNodeB, the serving base station may perform UL/DL CC indication processing. CC indication processing corresponds to a process of determining whether inter-eNodeB determined in a predetermined link (e.g., DL) is valid in another eNodeB.

For example, in a state where DL BCcc indicating inter-eNodeB is determined according to the aforementioned A. algorithm, DL/UL CC indication processing may be performed. The above process may correspond to a process of considering whether to change UL in a state where even DL UCcc being currently used by a serving base station may transmit data. When BCcc is determined as inter-eNodeB in a UL aspect, DL/UL CC indication may be determined as true whereby a subsequent procedure may be proceeded for inter-eNodeB HO. However, when BCcc is determined as intra-eNodeB in a UL aspect, true or false may be determined by collectively analyzing BCcc of inter-eNodeB meaning and BCcc of intra-eNodeB meaning, obtained from A. algorithm. If true, the subsequent procedure may be performed for inter-eNodeB HO. If false, a process of finding BCcc in intra-eNodeB in a state where DL BCcc that is a result of A. algorithm is excluded.

Similarly, in a state where UL BCcc indicating inter-eNodeB is determined according to the aforementioned B. algorithm, UL/DL CC indication processing may be performed. The above process may correspond to a process of considering whether to change DL in a state where even UL UCcc being currently used by the serving base station may transmit data. When BCcc is determined as inter-eNodeB in a DL aspect, UL/DL CC indication may be determined as true whereby a subsequent procedure may be proceeded for inter-eNodeB HO. However, when BCcc is determined as intra-eNodeB in a DL aspect, true or false may be determined by collectively analyzing BCcc of inter-eNodeB meaning and BCcc of intra-eNodeB meaning, obtained from B. algorithm. If true, the subsequent procedure may be performed for inter-eNodeB HO. If false, a process of finding BCcc in intra-eNodeB in a state where UL BCcc that is a result of B. algorithm is excluded.

If the indication is true, the serving base station may follow a negotiation result using 4-1 and 4-2 of Table 4. Conversely, if the indication is false, the serving base station may recalculate satisfying BCcc in intra-eNodeB in a state where the determined inter-eNodeB BCcc is excluded.

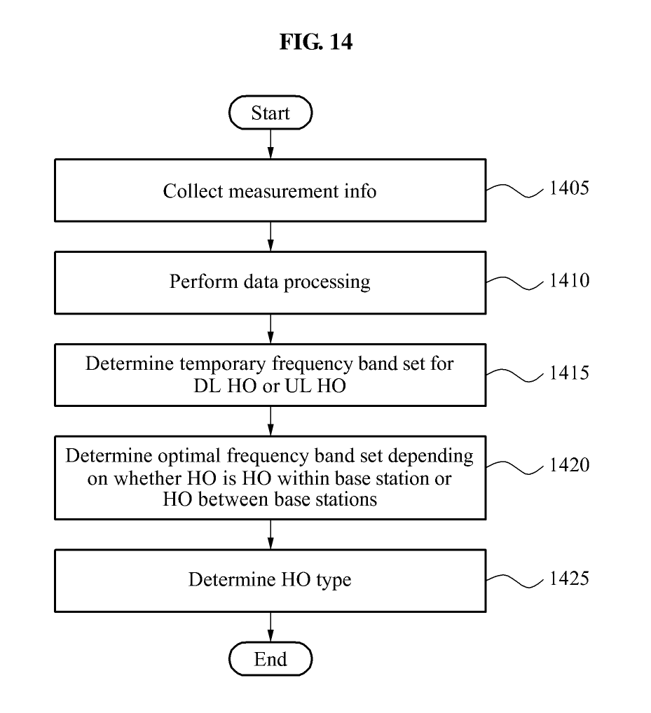

FIG. 14 is a flowchart illustrating a method of determining a type of a handover of a serving base station being currently connected by a UE in a wireless mobile communication system using CA according to an embodiment of the present invention.

In operation 1405, a serving base station may collect measurement information required to determine an optimal frequency band set to be used for the handover.

In operation 1410, the serving base station may perform data processing of the collected measurement information. Operation 1410 is similar to operation 910 of FIG. 9.

In operation 1415, the serving base station may determine a temporary frequency band set for DL HO or a temporary frequency band set for UL HO. The temporary frequency band set for DL HO may be, for example, DL BCcc described above with reference to FIG. 9. The temporary frequency band set for UL HO may be, for example, UL BCcc described above with reference to FIG. 9. Operation 1415 is similar to operation 915 or 945 of FIG. 9.

In operation 1420, the serving base station may determine an optimal frequency band set for UL HO or DL HO, depending on whether the determined temporary frequency band set supported by the serving base station, and whether the determined temporary frequency band set supported by a neighboring base station of the serving base station. Specifically, the serving base station may determine the optimal frequency band set depending on whether the determined temporary frequency band set corresponds to HO within a base station, or HO between base stations. Operation 1420 is similar to operations 920 through 940 of FIG. 9 or operations 950 through 970.

When the determined temporary frequency band set is the optimal frequency band set for DL HO, and supported by the neighboring base station, the optimal frequency band set for UL HO may be selected from the neighboring base station or the serving base station in operation 1420, which is similar to operation 935 or 940 of FIG. 9.

Also, when the determined temporary frequency band set is the optimal frequency band set for UL HO, and supported by the neighboring base station, the optimal frequency band set for DL HO may be selected from the neighboring base station or the serving base station in operation 1420, which is similar to operation 965 or 970 of FIG. 9.

In operation 1425, the serving base station may determine a HO type based on a number of frequency bands within a frequency band set (e.g., DL UCC or UL UCcc) being used by the UE and a number of frequency bands within the optimal frequency band set (e.g., DL BCcc or UL BCcc).

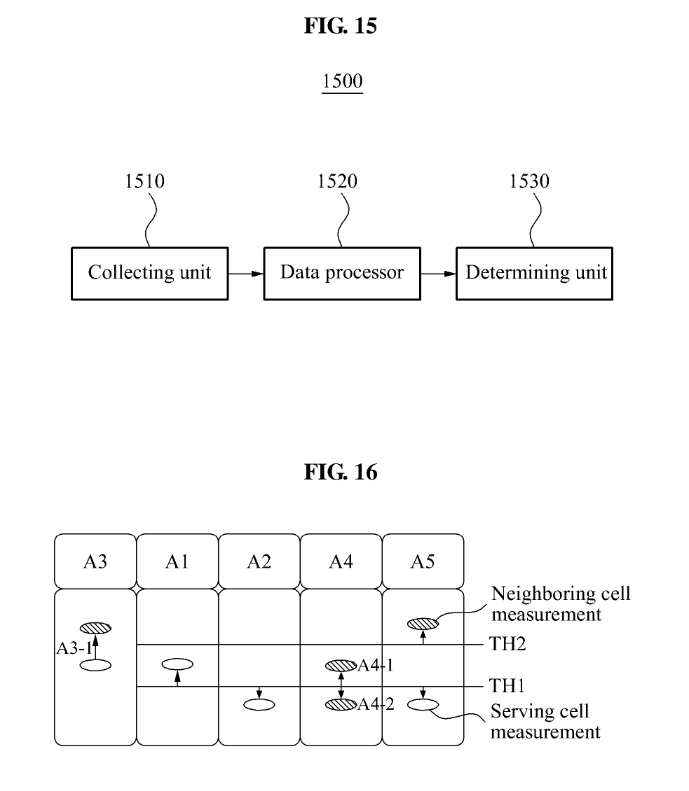

FIG. 15 is a block diagram illustrating a serving base station 1500 for determining a type of a handover of a UE in a wireless mobile communication system using a CA according to an embodiment of the present invention.

Referring to FIG. 15, the serving base station 1500 may include a collecting unit 1510, a data processor 1520, and a determining unit 1530. The serving base station 1500 may be the serving base station described above with reference to FIG. 1 through FIG. 14.

The collecting unit 1510 may collect measurement information required to determine an optimal frequency band set to be used for the handover.

The data processor 1520 may perform data processing of the collected measurement information, and thereby determine a temporary frequency band set (DL BCcc, UL BCcc) for DL HO or UL HO.

The determining unit 1530 may determine the optimal frequency band set for DL HO or UL HO, depending on whether the determined temporary frequency band set supported by the serving base station 1500 and whether the determined temporary frequency band set supported by a neighboring base station of the serving base station.

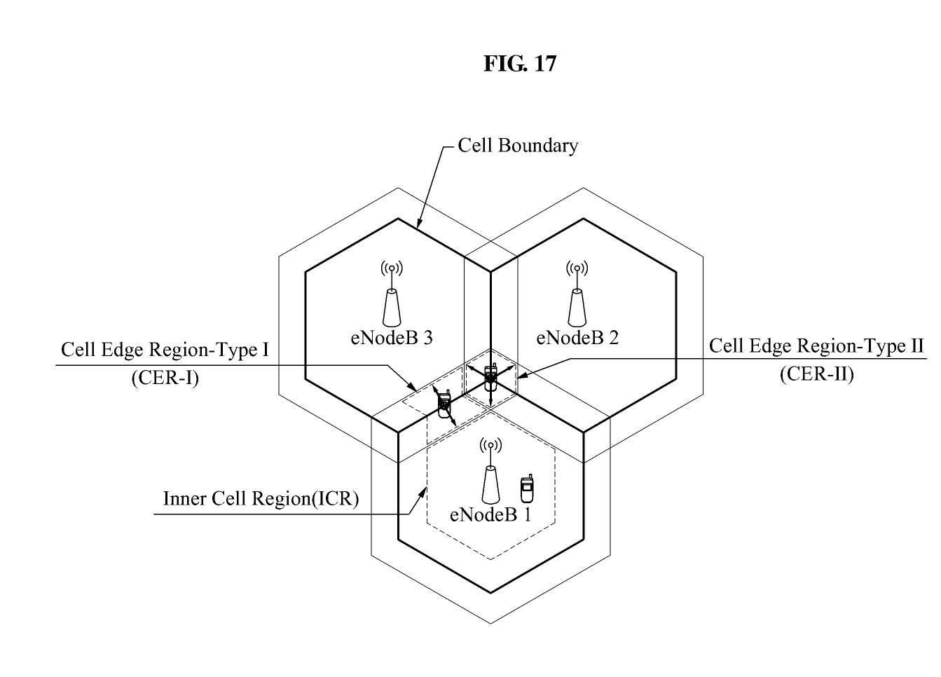

FIG. 16 and FIG. 17 are diagrams to describe a method of automatically reserving and cancelling a resource in a CA environment according to an embodiment of the present invention.

In FIG. 16, an oval indicated by a diagonal line indicates DLENBCCSNR with respect to a neighboring cell, and an oval indicated by a non-diagonal line indicates DLENBCCSNR with respect to a serving cell. Also, the oval corresponds to a measurement value measured in L1 of the UE of FIG. 2, and a value collected by D-RRM of a current serving base station using the RRC interface of FIG. 3. The measurement value measured in the L1 of the UE corresponds to DL Meas. or DLENBCCSNR (Parm 3-2) of Table 3, and a value with respect to CC of a serving base station and neighboring base stations, measured by the UE in a current position.

Events cited in the present invention may include A4-1, A4-2, and A3-1. A4-1 indicates an event where DLENBCCSNR of a neighboring base station becomes to be greater than a reference value TH1, and A4-2 indicates an event where DLENBCCSNR of the neighboring base station becomes to be less than the reference value TH1. A3-1 indicates an event where DLENBCCSNR of the neighboring base station becomes to be greater than DLENBCCSNR of the current serving base station.

In the present invention, TH1 of A4-1 is referred to as T_{PREP}, and TH1 of A4-2 is referred to as T_{RMT}. T_{PREP} and T_{RMT} may be set to be the same as each other or to be different from each other. When DLENBCCSNR of the neighboring base station becomes to be greater than T_{PREP}, that is, when the event of A4-1 occurs, the serving base station may prepare a resource through information exchange with the neighboring base station. Also, when DLENBCCSNR of the neighboring base station becomes to be less than T_{RMT}, the serving base station may release the prepared resource through information exchange with a corresponding base station.

FIG. 17 is a diagram logically illustrating a region for each position with the assumption that T_{RMT}=T_{PREP} in FIG. 16.

Referring to FIG. 17, eNodeB 1, eNodeB 2, and eNodeB 3 correspond to base stations, and Inner Cell Region (ICR), Cell Edge Region—Type I (CER-I), and Cell Edge Region—Type II (CER-II) correspond to types of regions where a UE may be positioned.

The UE may be positioned in ICR, CER-I, or CER-II based on an A4-1, A4-2 event satisfaction condition with respect to neighboring DLENBCCSNR values. Specifically, that the UE is positioned in ICR may indicate that all of DLENBCCSNR values with respect to all CCs of neighboring base stations are less than T_{PREP}.

That the UE is positioned in CER-I may indicate that all of DLENBCCSNR values with respect to all CCs of neighboring base stations are greater than T_{PREP}, and also exist in only a single neighboring base station. Also, that the UE is positioned in CER-II may indicate that all CCs of neighboring base stations are greater than T_{PREP}, and also exist in at least two neighboring base stations.

In the case of the automatic resource reservation and cancellation in the CA environment proposed according to an embodiment of the present invention, resource reservation and cancellation may be performed with respect to neighboring base stations along the region of FIG. 17. Accordingly, when a handover in a cell boundary is determined, the handover may be immediately performed. The automatic resource reservation may be performed by means of neighboring base stations having triggered A4-1. Triggering of A4-1 may indicate that DL quality (DLENBCCSNR) is greater than TH1 and thus, the quality of the neighboring base station is excellent. Also, the automatic resource cancellation may be performed by means of neighboring base stations having triggered A4-2. Triggering of A4-2 may indicate that the DL quality (DLENBCCSNR) is greater than TH1 and thus, the quality of the serving base station is more excellent than the quality of the neighboring base station.

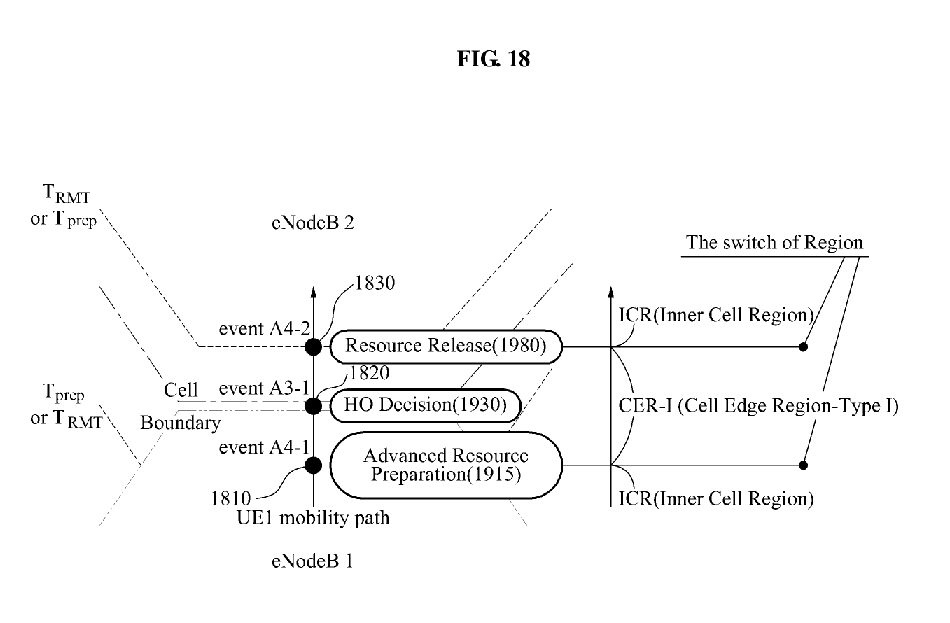

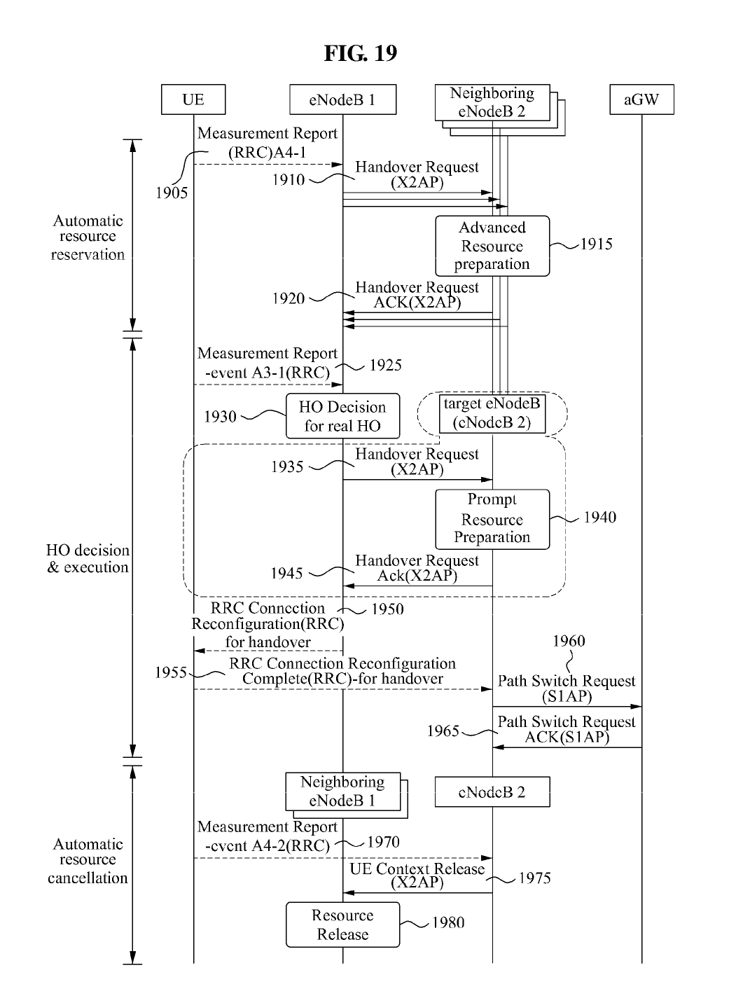

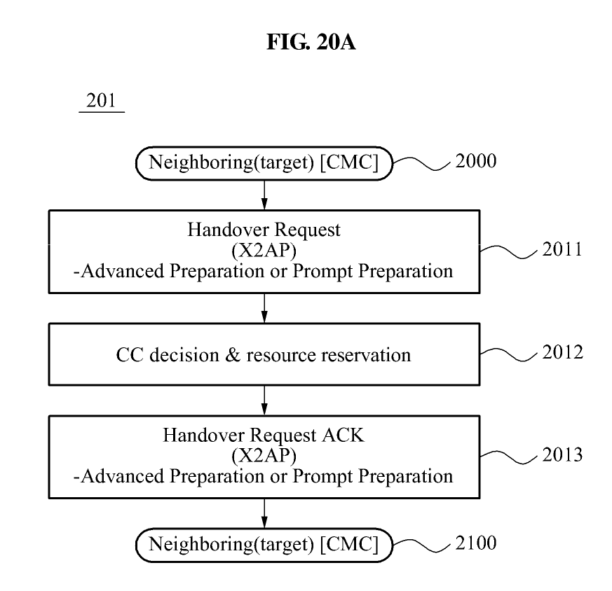

FIG. 18 and FIG. 19 are a scenario and a flowchart to describe a process of applying inter-eNodeB HO according to an embodiment of the present invention.

FIG. 18 shows a scenario where a UE is handed over from eNodeB 1 to eNodeB 2 with the assumption that T_{RMT}=T_{PREP}. When the UE is positioned in a position 1810, and when DLENBCCSNR becomes to be greater than T_{PREP}, eNodeB 1 that is a current serving base station may induce eNodeB 2 to perform advanced resource preparation in operation 1915.

When the UE is positioned in a position 1820, and when event A3-1 where DLENBCCSNR with respect to random CCs of eNodeB 2 becomes to be greater than a DLENBCCSNR value of CC being used by the UE in eNodeB 1 occurs, eNodeB 1 may perform HO decision and execution in operation 1930. Accordingly, the serving base station is changed from eNodeB 1 to eNodeB 2. eNodeB 1 becomes a neighboring base station of eNodeB 2.

When the UE is positioned in a position 1830, and when event A4-2 where DLENBCCSNR value with respect to CCs of eNodeB 2 becomes to be less than T_{RMT} occurs, eNodeB 2 that is a current serving base station may instruct eNodeB 1, which is a corresponding neighboring base station, to perform resource release in operation 1980.

FIG. 19 illustrates a flow according to the scenario of FIG. 18. According to the scenario of FIG. 18, an automatic resource reservation, a HO decision and execution, and an automatic resource cancellation may be sequentially performed.

The automatic resource reservation and cancellation may be performed based on DLENBCCSNR measured by the UE. With respect to CC of neighboring base stations

having triggered A4-1, a serving base station and a neighboring base station enable advanced resource preparation in operation 1915 by transmitting and receiving handover request in operation 1910 and handover request ACK in operation 1920 using an X2AP protocol message.

With respect to CC of neighboring base stations having triggered A4-2, the serving base station and the neighboring base station enable resource release of operation 1980 using an X2AP protocol message, i.e., UE context release of operation 1975.

The UE may provide measured DLENBCCSNR values to the serving base station using an RRC protocol message that is a measurement report. The serving base station enables CMC of D-RRM to directly determine an event based on DLENBCCSNR collected in the D-RRM. The UE may directly determine the event through measurement control, and provide the determined event to the serving base station using the RRC protocol message that is a measurement report (see operations 1905, 1925, and 1970).

In operation 1905, the UE may report event A4-1 in a form of a measurement report message. The event A4-1 corresponds to an event according to DLENBCCSNR measured in neighboring base stations (eNodeB 2, eNodeB 3). The event A4-1 indicates that a result of measuring, by the UE, an SNR quality (DLENBCCSNR of Table 3) with respect to a reference signal of each CC of the neighboring base station (eNodeB2, eNodeB 3) increases to be above a threshold value T_{PREP} determined in a network.

The above measurement report message may be reported to the current serving base station (eNodeB 1) through an RRC interface. A handover request and a handover request ACK may be transmitted in an X2AP form whereby advanced resource preparation (operation 1915) with respect to corresponding neighboring base stations having triggered A4-1 is enabled.

In operation 1910, the current serving base station (eNodeB 1) may transmit the handover request to neighboring base stations (eNodeB 2, enodeB3) having triggered A4-1, using X2AP. Referring to FIG. 18, a base station having triggered the event A4-1 event in the position 1810 of the UE may transfer the handover request to eNodeB 2.

Information that needs to be included in operations 1910 and 1920 or in operations 1935 and 1945 in the CA environment are shown in Table 5. Additionally, Table 5 shows an embodiment of information to be substantially included with the following assumption.

The assumption for Table 5 follows as:

1. As shown in FIG. 7, eNodeB 71 uses CC1, CC2, and CC3 for DL, and uses CC4, CC5, and CC6 for UL, and eNodeB 1 and eNodeB 2 of FIG. 18 and FIG. 19 correspond to eNodeB 71.

2. In eNodeB 1, UE1 is using CC1, CC2, and CC3 for DL, and is using CC6 for UL. After the UE1 is handed over to eNodeB 2, the UE1 uses CC3 for DL and uses CC5 for UL.

3. HO is executed according to UE1 mobility path of FIG. 18 and the procedure of FIG. 19.

4. Like the base station 62 of FIG. 6, eNodeB 1 is operated so that only CC2 and CC3 may have a full coverage and CC1 may not have a full coverage in DL, and only CC5 and CC6 among CC4, CC5, and CC6 may have a full coverage in UL.

5. Like the base station 64 of FIG. 6, eNodeB2 operates CC1, CC2, and CC3 with a full coverage for DL, and operates CC4, CC5, and CC6 with a full coverage for UL.

TABLE 5

| X2AP | | |
|---|---|---|
| message | information group and information | |
| Handover | (Parm 4-1-1) | UE1 ID |
| Request (4-1) | UE ID (information capable of | |
| | identifying corresponding UE, | |
| | which can be provided in any | |
| | type) | |
| | (Parm 4-1-2) | eNodeB 1 {ULGQ_{UE1} = 30, |
| | serving eNodeB ID {Table 1's | DLGQ_{UE1} = 40} |
| | (Parm 1-4) ULGQ, DLGQ} | |
| | (Parm 4-1-3) | eNodeB 1 {DLCCGQ_{CC1} = 13, |
| | serving eNodeB ID {Table 1' | DLCCGQ_{CC2} = 12, DLCCGQ_{CC3} = |
| | (Parm 1-5)ULCCGQ, | 15, ULCCGQ_{CC6} = 30} |
| | DLCCGQ} | |
| | (Parm 4-1-4) | eNodeB 2 {CC2, CC3} |
| | In (Parm 3-2) of Table 3, | assumption that |
| | CC set with respect to | DLENBCCSNR_{UE1CC1eNodeB2,} |
| | corresponding base stations to | DLENBCCSNR_{UE1CC2eNodeB2,} |
| | transmit handover request | of eNodeB 2 satisfies |
| | among neighboring base | A4-1 based on information |
| | stations having, as a condition, | managed by eNodeB 1 D- |
| | DLENODEBCCSNR greater | RRM in position 1810 of |
| | than T_{PREP,} | FIG. 18 |
| | neighboring eNodeB ID to | |
| | transmit handover request{DL- | |
| | CC set} | |
| | (Parm 4-1-5) | eNodeB 1 {DL(CC1, CC2, CC3), |
| | serving eNodeB ID {used CC | UL(CC6)} |
| | set} | |
| | (information that can | |
| | be estimated through | |
| | Parm 4-13, and is | |
| | described for | |
| | convenience of | |
| | description) | |
| | (Parm 4-1-6) | eNodeB 1 {DL(CC2, CC3), |
| | serving eNodeB ID {Full | UL(CC5, CC6)} |
| | coverage DL CC set} | |
| | (Parm 4-1-7) | UEDLCapa(3) |
| | maximum number of CCs | UEULCapa(3)) |
| | supportable in UE1 | |
| | UEDLCapa, | |
| | UEULCapa | |
| Handover | (Parm 4-2-1) | UE1 ID |
| Request | UE ID (information capable of | |
| ACK (4-2) | identifying corresponding UE, | |
| | which can be provided in any | |
| | type) | |
| | (Parm 4-2-2) Success or Failure | Success |
| | Only if success, (Parm 4-5, 4-6, | |
| | 4-7) is valid information) | |
| | (Parm 4-2-3) | eNodeB 2 {DL(CC1, CC2, CC3), |
| | neighboring eNodeB ID | UL(CC5)} |
| | {available DU-CC set, UL-CC | assumption that when UE |
| | set} | is handed over to eNodeB2 |
| | | based on information |
| | | managed by eNodeB2 D- |
| | | RRM in position 1810 of |
| | | FIG. 18, available DL CC |
| | | set is determined as CC3 |
| | | and available UL CC set is |
| | | determined as 5. |
| | (Parm 4-2-4) | eNodeB 2 {ULGQ_{UE1} = |
| | neighboring eNodeB ID {Table | 30, DLGQ_{UE1} = 40} |
| | 1's (Parm 1-4) ULGQ, DLGQ} | |
| | (Parm 4-2-5) | eNodeB 2 {DLCCGQ_{CC1} = 10, |
| | neighboring eNodeB ID {Table | DLCCGQ_{CC2} = 8, |
| | 1's (Parm 1-5)ULCCGQ, | DLCCGQ_{CC31} = 22, |
| | DLCCGQ} | ULCCGQ_{CC5} = 30} |
| UE Context | (Parm 4-3-1) | UE1 ID |
| Release (4-3) | UE ID (information capable of | |
| | identifying corresponding UE, | |
| | which can be provided in any | |
| | type) | |
| | (Parm 4-3-2) | eNodeB 1 {DL(CC1, CC2, CC3), |
| | eNodeB ID used to receive UE | UL(CC6)} |
| | Context Release {using CC set | |
| | of corresponding base station | |
| | stored in serving base station} | |

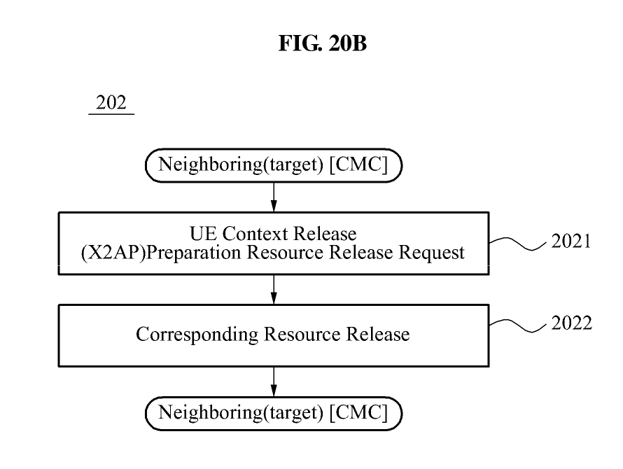

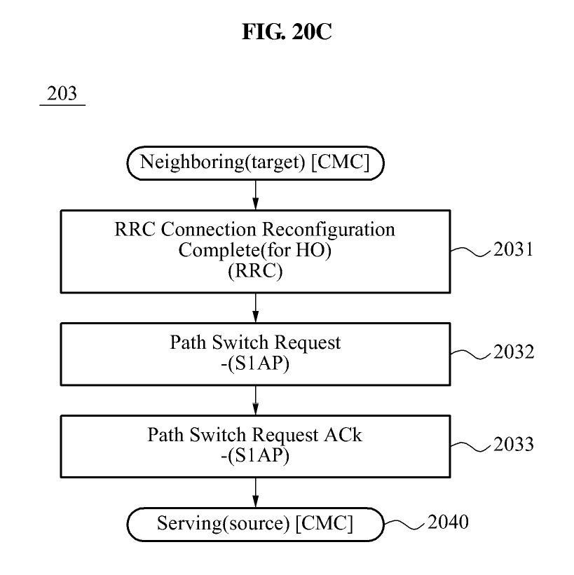

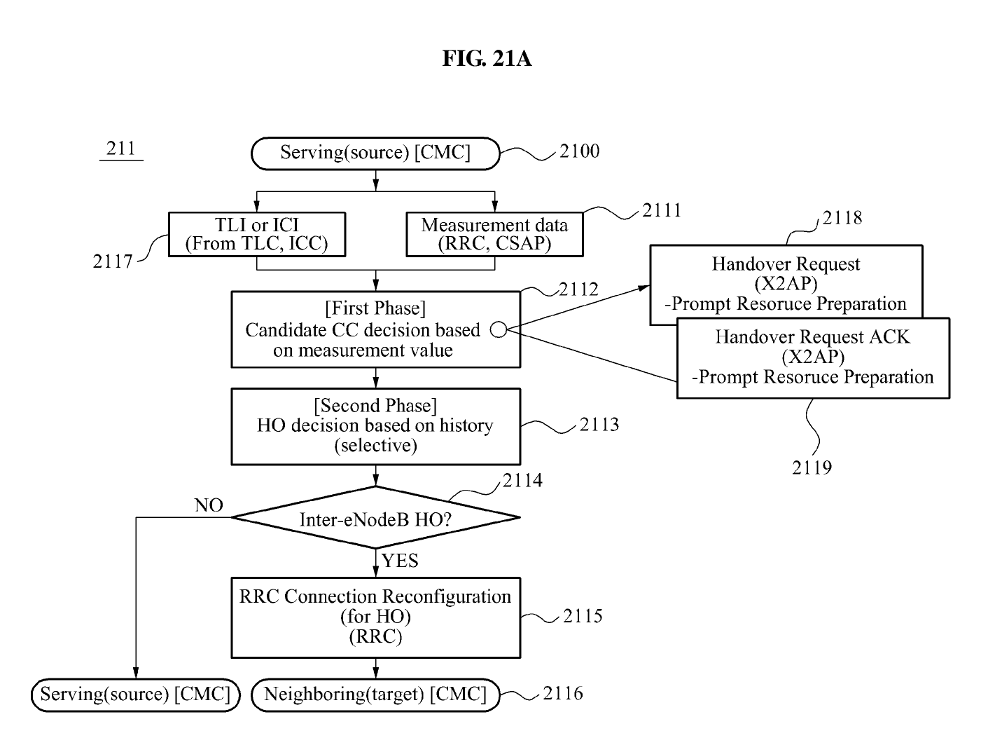

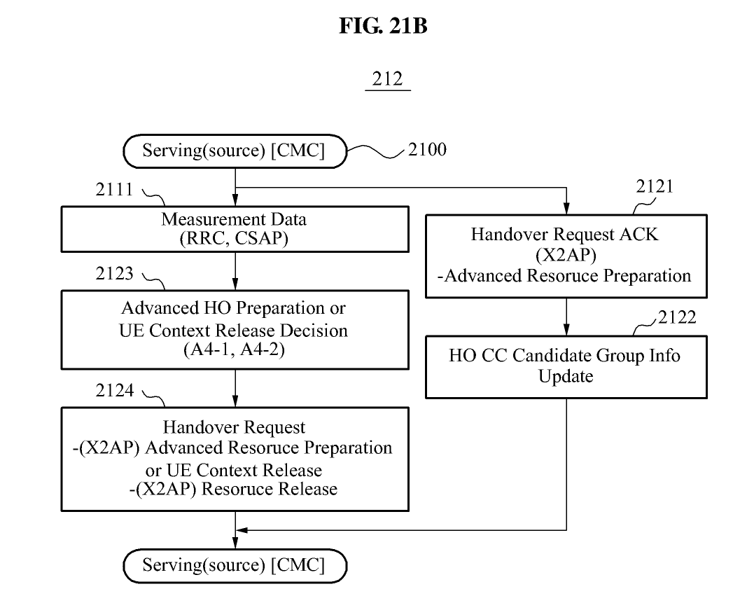

When UE is connected to a network, the UE may have a serving base station, and have a 1-tier neighboring base station based on the serving base station. Specifically, D-RRM of a base station may be in a “serving (source) [CMC]” state or a “neighboring (target) [CMC]” state. Due to the handover, the “serving (source) [CMC]” state may be switched to the “neighboring (target) [CMC]” state. Conversely, the “neighboring (target) [CMC]” state may be switched to the “serving (source) [CMC]” state. The above relationships are shown of FIGS. 20A, 20B, and 20C, and FIGS. 21A and 21B.

Advanced Resource Preparation of Operation 1915 in Automatic Resource Reservation of FIG. 19

The advanced resource preparation corresponds to a process of transmitting in advance a handover request to CC of a neighboring base station having triggered event A4-1 to thereby prepare a handover. In this CA environment, the neighboring base station receiving the handover request may prepare a handover with respect to a corresponding UE using a CC set of the neighboring base station, which is different from an existing handover. CMC of D-RRM of the neighboring base station may exclusively charge the handover to one of CCs of the neighboring base station, or may distribute the handover to a plurality of CCs. The neighboring base station may report to the serving base station about how the CCs are distributed, using handover request ACK.

A flow 201 of FIG. 20A shows an advanced resource preparation process of operation 1915 of FIG. 19.

In operation 2011, the neighboring base station (eNodeB 2) may receive a handover request for advanced HO preparation. The received handover request may include information corresponding to 4-1 message of Table 5.

In operation 2012, the neighboring base station (eNodeB 2) may perform CC decision and resource reservation based on the received information and neighboring base station circumstance.

In operation 2013, the neighboring base station (eNodeB 2) may include, in handover request ACK, information corresponding to 4-2 message of Table 5 and thereby transfer handover request ACT to a serving base station (eNodeB 1). Here, a process of determining information to be transmitted to the serving base station may follow the following algorithm.

Prompt resource preparation of operation 1940 in the handover decision and execution process of FIG. 19 is similar to advanced prompt preparation (operation 1915, 201 of FIG. 20A). Here, the handover request in eNodeB 1 is triggered by event A4-1

[Algorithm A] Advanced HO Preparation—a processing process in eNodeB 2 when eNodeB 2 receives a handover request message (4-1 of Table 5) from eNodeB 1:

1. Obtains information of eNodeB 2:
1.1 Verifying of current operating CC
   Ex.) eNodeB 2 {DL(CC1,CC2,CC3), UL(CC4,CC5,CC6)}
1.2 Verifying of full coverage CC
   Ex.) eNodeB 2 {DL(CC1,CC2,CC3), UL(CC4,CC5,CC6)}
1.3 Verifying of DLCCAC (Parm 2-1 of Table 2) and ULCCAC (Parm 2-2 of Table 2) in corresponding base station with respect to full coverage CC of 1.2
   Ex.) DLCCAC_{CC1}=10, DLCCAC_{CC2}=8, DLCCAC_{CC3}=30→indication
      ULCCAC_{CC4}=5, DLCCAC_{CC5}=30, DLCCAC_{CC6}=0→indication sorts in an order of ccindex as follows:

Ex.)

IE1_3.num=3{.DLCCAC[0].ccindex=1 DLCCAC[0].value = 10,

.DLCCAC[1].ccindex=2 DLCCAC[1].value = 8,
.DLCCAC[2].ccindex=3 DLCCAC[2].value = 30)

IE1_3.num=3{.ULCCAC[0].ccindex=4 ULCCAC[0].value = 5,

.ULCCAC[1].ccindex=5 ULCCAC[1].value = 30,
.ULCCAC[2].ccindex=6 ULCCAC[2].value = 0)

2. Processes information of 4-1 message of Table 5:
2.1 sorts for each of UL and DL in descending order of (Parm 4-1-3) in corresponding CC satisfying (full coverage) (Parm 4-1-6). In the case of DL, a condition of satisfying 4-1 message (Parm 4-1-4) of Table 5 can be included.
   Ex.) DL−eNodeB 1 {DLCCGQ_{CC1}=13, DLCCGQ_{CC2}=12, DLCCGQ_{CC3}=15}
      UL−eNodeB 1 {ULCCGQ_{CC6}=30}
   2.2 If a total sum of entities sorted in 2.1 is greater than a total sum of DL (or UL)CCAC[ ].values of 1.3, terminates all the processes and transmits Handover Request Failure that is a failure response to 4-1 message of Table 5. If the total sum of entities is less than the total of DL (or UL)CCAC[ ].values, entities having the same ccindex (e.g., x) may be compared. Here, if (DL or UL) CCGQccx is greater than DLCCAC[ ].value that is ccindex=x, a corresponding difference is accumulatively stored as ccindex=none.
   Ex.) Total sum of entities sorted in 2.1 (DL)
   eNodeB1 DLGQ=13+12+15=40
   Ex.) Total sum of entities sorted in 2.1 (UL)
   eNodeB 1 ULGQ=30
   Ex.) Total sum of eNodeB2 DLCCAC[ ].values in 1.3=DLCCAC[0].value (10) of ccindex=1+DLCCAC[1].value (8) of ccindex=2+DLCCAC[2].value (30) of ccindex=3=48
   Ex.) Total sum of eNodeB2 ULCCAC[ ].values in 1.3=DLCCAC[0].value (5) of ccindex=4+DLCCAC[1].value (30) of ccindex=5+DLCCAC[2].value (0) of ccindex=6=35
   Ex.)
   [In the case of DL] In the above example, the total sum of entities sorted in 2.1 (DL) 40 is less than the total sum of DLCCAC[ ].values 48 and thus, Handover Request Failure processing may not be performed. However, verification may need to be performed with respect to UL.
   [In the case of UL] Similarly, in the above example, the total sum of entities sorted in 2.1 (UL) 30 is less than the total sum of ULCCAC[ ].values 35 and thus, Handover Request Failure processing may not be performed. Unless at least one of UL and DL satisfies a condition, Handover Request Failure processing may not be performed.
   Ex.) Example of “accumulatively storing corresponding difference as ccindex=none”
   [In the case of DL]
   If ccindex=1, eNodeB 1 {DLCCGQ_{CC1}=13} and eNodeB2 DLCCAC[0].value=10 and thus, the former is greater than the latter. Accordingly, the corresponding difference (13−10=3) is stored as DLCCGQccnone=3. In addition, IE2_{—}2 entry addition (ccindex=none, value=3) together with IE2_{—}2 entry addition (ccindex=1, value=10)
   If ccindex=2, eNodeB 1 {DLCCGQ_{CC2}=12} and eNodeB2 DLCCAC[1].value=8 and thus, the former is greater than the latter. Accordingly, the corresponding difference (12−8=4) is stored as DLCCGQccnone=7 by accumulating ‘4’ to DLCCGQccnone=3. Also, IE2_{—}2 entry addition (ccindex=2, value=8)
   If ccindex=3, eNodeB 1 {DLCCGQ_{CC3}=15} and eNodeB2 DLCCAC[2].value=30 and thus, the former is less than the latter. Accordingly, there is no change in an existing accumulated value DLCCGQccnone=7. Also, IE2_{—}2 entry addition (ccindex31, value=15)
   [In the case of UL]
   If ccindex=6, eNodeB 1 {ULCCGQ_{CC6}=30} and eNodeB2 ULCCAC[3].value=0 and thus, the former is greater than the latter. Accordingly, the difference therebetween 3(0−0=30) is DLCCGQccnone=30. Also, IE2_{—}2 entry addition (ccindex=none, value=30)
   Ex.)
   In the above example, IE with respect to DL is determined as follows:

IE2_2.num=4{.DLCCGQ[0].ccindex=1 DLCCGQ [0].value = 10,

. DLCCGQ [1].ccindex=2 DLCCGQ [1].value = 8,
. DLCCGQ [2].ccindex=3 DLCCGQ [2].value = 15,
. DLCCGQ [3].ccindex=none DLCCGQ [3].value = 7)

In the above example, UL is determined as follows: IE2_{—}2.num=1{. ULCCGQ [0].ccindex=none ULCCGQ [0].value=30}

3. Performs processing so as to determine Parm 4-2-3, 4-2-4, and 4-2-5 in 4-2 message of Table 5.
3.1 Result Structure Initialization
   Result structure initialization ((DL or UL)Result.num(DL or UL)Result.(DL or UL)CCGQH.ccindex, Result.(DL or UL)CCGQH.num)—indicates a structure where a result for generating 4-2 message value of Table 5 is stored.
3.2 eNodeB2 may use a variety of schemes to determine HO type. Here, result information is obtained through the following three steps of an algorithm where split does not occur while maximally maintaining CC used by eNodeB 1. However, the algorithm can be modified for minimizing split. A number of CCs supportable by UEULCapa and UEDLCapa of information (Parm 4-1-7) of 4-1 message of Table 5 that is an additional condition may also be considered.

3.2.1 Algo. 3.2.1

Algo. 3.2.1 == start

Step. 1
(DL or UL)Result.num =0;
for(i=0;i< (DL or UL) IE2_2.num;i++)
{ //1

for(j=0;j< (DL or UL) IE1_3.num;j++)
{ //2

if(IE2_2.(DL or UL)CCGQ[i].ccindex == IE1_3.(DL or UL)CCAC[j].ccindex)
{ //3

if(IE2_2.(DL or UL)CCGQ[i].value =< IE1_3.(DL or UL)CCAC[j].value)
{ //4

(DL or UL)Result.(DL or UL)CCGQ[(DL or UL)Result.num].ccindex = IE1_3.(UL or DL)CCAC[j].ccindex;
(DL or UL)Result.(DL or UL) CCGQ[(DL or UL)Result.num].value = (DL or UL)Result.(DL or

UL)CCGQ.value + IE2_2.(DL or UL)CCGQ[i].value;

IE1_3.(UL or DL)CCAC[j].value = IE1_3.(UL or DL)CCAC[j].value − IE2_2.(DL or UL)CCGQ[i].value;

(DL or UL)Result.num++;

} //4

} //3

} //2

```
  } //1
  Ex.) if going through Step. 1
```

IE1_3.num=3{.DLCCAC[0].ccindex=1 DLCCAC[0].value = 0,

.DLCCAC[1].ccindex=2 DLCCAC[1].value = 0,
.DLCCAC[2].ccindex=3 DLCCAC[2].value = 15)

IE1_3.num=3{.ULCCAC[0].ccindex=4ULCCAC[0].value = 5,

```
  .ULCCAC[1].ccindex=5 ULCCAC[1].value = 30,
  .ULCCAC[2].ccindex=6 ULCCAC[2].value = 0)
```

(DL)Result.num=3{.DLCCGQ[0].ccindex=1 DLCCGQ [0].value = 10,

.DLCCGQ [1].ccindex=2 DLCCGQ [1].value = 8,
.DLCCGQ [2].ccindex=3 DLCCGQ [2].value = 15)

(UL)Result.num=0{ }

Step. 2
sorts IE1_3 information in a descending of a value size.
Ex.) if going through Step. 2,

IE1_3.num=3{.DLCCAC[0].ccindex=3 DLCCAC[0].value = 15,

.DLCCAC[1].ccindex=1 DLCCAC[1].value = 0,
.DLCCAC[2].ccindex=2 DLCCAC[2].value = 0)

IE1_3.num=3{.ULCCAC[0].ccindex=5 ULCCAC[0].value = 30,

```
  .ULCCAC[1].ccindex=4 ULCCAC[1].value = 5,
  .ULCCAC[2].ccindex=6 ULCCAC[2].value = 0)
```

Step. 3, xx, bool corresponds to variables indicating integer
No 3;
xx = (DL or UL) Result.num;
for(i=0;i< (DL or UL) IE2_2.num;i++)
{ //1

if(IE2 2.(DL or UL)CCGQ[i].ccindex == none)
{ //2

for(j=0;j<(DL or UL) IE1_3.num;j++)
{ //3

Algo 3.2.1-1

} //3

} //2

}//1
(DL or UL) Result.num = xx;

Algo. 3.2.1 == end
Algo 3.2.1-1 == start

if(IE1_3.(DL or UL)CCAC[j].value > 0)
{

If(IE2_2.(DL or UL)CCGQ[i].value<= IE1_3.(DL or UL)CCAC[j].value)
{

Algo 3.2.1-1-1

}
else
{

Algo 3.2.1-1-2

}

if(IE2_2.(DL or UL)CCGQ[i].value <= 0) break; //ccindex=none only

}

Algo 3.2.1-1 == end
Algo 3.2.1-1-1 == start

```
  bool =0;
  for(k=0;k<((DL or UL) Result.num);k++) //4
  {
```

```
  if(Result.(DL or UL)CCGQ[k].ccindex == IE1 3.(DL or UL)CCAC[j].ccindex)
  {
```

(DL or UL)Result.(DL or UL) CCGQ[k].value = (DL or UL)Result.(DL or UL) CCGQ[k].value + IE2_2.(DL or UL)CCGQ[i].value;

```
IE1_3.(UL or DL)CCAC[j].value = IE1_3.(UL or DL)CCAC[j].value − IE2_2.(DL or UL)CCGQ[i].value;
  bool = 1;
  IE2_2.(DL or UL)CCGQ[i].value = 0; //3 escape condition
  break; //4 escape
}
```

} //4
if(bool != 1)

{

(DL or UL)Result.(DL or UL) CCGQ[xx].ccindex= IE1_3.(DL or UL)CCAC[j].ccindex;
(DL or UL)Result.(DL or UL) CCGQ[xx].value = (DL or UL)Result.(DL or UL) CCGQ[xx].value + IE2_2.(DL or

UL)CCGQ[i].value;

IE1_3.(UL or DL)CCAC[j].value = IE1_3.(UL or DL)CCAC[j].value − IE2_2.(DL or UL)CCGQ[i].value;
IE2_2.(DL or UL)CCGQ[i].value = 0; //3 escape condition
xx = xx+1
}

Algo 3.2.1-1-1 == end
Algo 3.2.1-1-2 == start

```
  bool =0;
  for(k=0;k<((DL or UL) Result.num);k++) 115
  {
```

if(Result.(DL or UL)CCGQ[k].ccindex == IE1 3.(DL or UL)CCAC[j].ccindex)
{

(DL or UL)Result.(DL or UL) CCGQ[k].value = (DL or UL)Result.(DL or UL) CCGQ[k].value + IE1_3.(DL or UL)CCAC[j].value;

IE1 3.(UL or DL)CCAC[j].value = 0;
IE2 2.(DL or UL)CCGQ[i].value = IE2 2.(DL or UL)CCGQ[i].value − IE1 3.(DL or UL)CCAC[j].value;

bool = 1;
break; //5 escape

}

} //5
if(bool != 1)
{
(DL or UL)Result.(DL or UL) CCGQ[xx].ccindex= IE1_3.(DL or UL)CCAC[j].ccindex;

(DL or UL)Result.(DL or UL) CCGQ[xx].value = (DL or UL)Result.(DL or UL) CCGQ[xx].value + IE1_3.(DL or UL)CCAC[j].value;

IE1_3.(UL or DL)CCAC[j].value = 0;
IE2_2.(DL or UL)CCGQ[i].value = IE2_2.(DL or UL)CCGQ[i].value − IE1_3.(DL or UL)CCAC[j].value;
xx = xx+1
(DL or UL) Result.num = xx;
go to no3;

}

Algo 3.2.1-1-2 == end

Ex.) if going through Step. 3, Algo 3.2.1-1-1 is applied in the above example.

IE1_3.num=3{.DLCCAC[0].ccindex=3 DLCCAC[0].value = 8,

.DLCCAC[1].ccindex=1 DLCCAC[1].value = 0,
.DLCCAC[2].ccindex=2 DLCCAC[2].value = 0)

IE1_3.num=3{.ULCCAC[0].ccindex=5 ULCCAC[0].value = 0,

```
  .ULCCAC[1].ccindex=4 ULCCAC[1].value = 5,
  .ULCCAC[2].ccindex=6 ULCCAC[2].value = 0)
```

IE2_2.num=4{.DLCCGQ[0].ccindex=1 DLCCGQ [0].value = 10, //no change

```
  .DLCCGQ [1].ccindex=2 DLCCGQ [1].value = 8, // no change
  .DLCCGQ [2].ccindex=3 DLCCGQ [2].value = 15, // no change
.DLCCGQ [3].ccindex=none DLCCGQ [3].value = 0) //7→change to 0
```

IE2_2.num=1 {. ULCCGQ [0].ccindex=none ULCCGQ [0].value = 0) //30→ change to 0

(DL)Result.num=3{.DLCCGQ[0].ccindex=1 DLCCGQ [0].value = 10, // no change

.DLCCGQ [1].ccindex=2 DLCCGQ [1].value =8, //no change
.DLCCGQ [2].ccindex=3 DLCCGQ [2].value = 22) //15-22

(UL) Result.num=1{.ULCCGQ[0].ccindex=5 ULCCGQ [0].value = 30) //entry addition, to ccindex=5 value 0→ 30

assignment

4. Generates 4-2 Message of Table 5 Based on Result Obtained from 3.
4.1 if a requirement condition of (Parm 4-1-2) of Table 5 is not accepted through the result of 3, (Parm 4-2-2) is FAIL (described above as Handover Request Failure), and if accepted, SUCCESS.
4.2 If SUCCESS, configures (Parm 4-2-5) by immediately extracting ccindex and value of (DL or UL)CCGQ from the result, obtains ULGQ through a sum of ULCCGQ with respect to UL, and obtains DLGQ through a sum of DLCCGQ with respect to DL. Also, configures (Parm 4-2-4) using the obtained values, and configures (Parm 4-2-3) by extracting only ccindex.

Ex.) If collecting the result of 3, each IE of 4-2 message of
Table 5 according to the above process follows as:

(Parm 4-2-3) eNodeB2{ DL(CC1,CC2,CC3), UL(CC5))
(Parm 4-2-4) eNodeB2{ULGQ 40(=10+8+22), DLGQ 30)
(Parm 4-2-5) eNodeB2(DLCCGQcc1 10, DLCCGQcc2 8,
DLCCGQcc3 22, ULCCGQcc5 30)

A flow 212 of FIG. 21B is a flowchart to describe a process of triggering advanced resource preparation.

A “serving (source) [CMC]” state 2100 indicates a state of eNodeB 1 in the scenario of FIG. 18 (position 1810 of UE1) and the automatic resource operation of FIG. 19.

In operation 2111, a serving base station (eNodeB 1) may collect measurement data using RRC and CSAP.

When event A4-1 occurs based on the collected data, the serving base station (eNodeB 1) may transmit a handover request to a neighboring base station having triggered A4-1. Here, the handover request is to request advanced resource preparation.

In operation 2121, the neighboring base station may transmit handover request ACK to the serving base station (eNodeB 1), and may perform advanced resource preparation.

In operation 2122, the neighboring base station may store or update information contained in the handover request. For example, the information may include HO CC candidate group information and Parm 4-2-1 through 5 of Table 5.

<Resource Release of Operation 1980 in Automatic Resource Cancellation of FIG. 19>

(Position 1830 of UE1 of FIG. 18, Flow 202 of FIG. 20b, Flow 212 of FIG. 21b)

According to the scenario of FIG. 18, when UE1 is positioned in the position 1830, event A4-2 may occur with respect to random CC of eNodeB 1. Referring to the automatic resource cancellation process of FIG. 19, since HO decision and execution is performed in the position 1820 of UE1 according to the scenario of FIG. 18, a current serving base station is eNodeB 2 and a neighboring base station is eNodeB 1.

Accordingly, in operation 1970, UE may transfer, to the serving base station (eNodeB 2), event A4-2 with respect to eNodeB 1 and a measurement value to determine event A4-2 through a measurement report that is an RRC protocol message. Specifically, the measurement report may be transferred to CMC of D-RRM of the serving base station (eNodeB 2).

In operation 1975, the serving base station (eNodeB 2) may transmit, to the neighboring base station (eNodeB 1) having triggered A4-2, UE context release that is an X2AP protocol message.

In operation 1980, the neighboring base station (eNodeB 1) may perform resource release. Internal information of UE context release that is the X2AP protocol message may include (Parm 4-3-1) and/or (Parm 4-3-2) information of Table 5.

Referring to the scenario of FIG. 18, in the advanced HO preparation processing operation 1915 of FIG. 19or the prompt resource preparation processing operation 1940, when the handover request is received in operation 1915 or 1935, eNodeB 2 that used to be the neighboring base station may store (Parm 4-1-6) and (Parm 4-1-1) of Table 5. Accordingly, the current serving base station (eNodeB 2) may transmit related information to the base station (eNodeB 1) having triggered event A4-2. Here, the related information may be stored in the serving base station (eNodeB 2).

The flow 202 of FIG. 20B illustrates a processing process after receiving the UE context release message.

In operation 2021, the neighboring base station (eNodeB 1) may receive the UE context release message in the “neighboring (target) [CMC]” of CMC.

In operation 2022, the neighboring base station (eNodeB 1) may release a resource with respect to corresponding UE.

The flow 212 of FIG. 21B illustrates a process of triggering UE context release.

In the flow 212, a “serving (source) [CMC]” state indicates a state where UE1 of FIG. 18 is positioned in the position 1830, and a state of eNodeB 2 in the automatic resource cancellation process of FIG. 19.

In operation 2111, the serving base station (eNodeB 2) may collect measurement data using RRC and CSAP.

In operation 2123, the serving base station (eNodeB 2) may perform advanced HO preparation, or may determine UE context release based on the collected measurement data.

In operation 2124, when event A4-2 occurs by determining the UE context release, the serving base station (eNodeB 2) may transmit UE context release (resource release) to the neighboring base station having triggered A4-2

<HO Decision and Execution Process of FIG. 19>

(UE1 of FIG. 18 in Position 1820, Flow 203 of FIG. 20c, Flow 211 of FIG. 21a)

Hereinafter, an example where eNodeB 1 uses CC1, CC2, and CC3 as DLCC in a state where UE1 of FIG. 18 is positioned in the position 1820, and CC2 and CC3 have a full coverage.

In operation 1930 of FIG. 19, when CC having a reference signal (RS) greater than a measurement value of RS of the serving base station (eNodeB 1) exists in the neighboring base station (eNodeB 2), that is, when event A3-1 occurs, a handover of the serving base station (eNodeB 1) may be determined. The measurement value of RS of the serving base station (eNodeB 1) is DLENBCCSNR_{UE1CC1eNodeB1} or DLENBCCSNR_{UE1CC1eNodeB1}.

In general, in operation 1920, the serving base station (eNodeB 1) may receive the X2AP message with respect to a base station having triggered A3-1, and store information of (Parm 4-2-1 to 5) of Table 5.

When a handover to the neighboring base station (eNodeB 2) is determined in operation 1920, the serving base station (eNodeB 1) may transfer, to the UE, an RRC ConnectionReconfiguration message for the handover in operation 1950.

However, even though the handover to the neighboring base station (eNodeB 2) is determined in operation 1930, information of (Parm 4-2-1 to 5) associated with the neighboring base station (eNodeB 2) may not be stored in the serving base station (eNodeB 1). In this case, in operation 1935, the serving base station (eNodeB 1) may transfer the handover request to the neighboring base station (eNodeB 2).

In operation 1940, the neighboring base station (eNodeB 2) may perform prompt resource preparation so as to obtain information. Operation 1940 is the same as the aforementioned operation 1915 of FIG. 19 and the flow 201 of FIG. 20A.

Specifically, when information of (Parm 4-2-1 to 5) associated with the neighboring base station (eNodeB 2) exists after the HO decision, the serving base station (eNodeB 1) may immediately transmit, to the UE, RRC ConnectionReconfiguration for HO in operation 1950. Conversely, when information of (Parm 4-2-1 to 5) does not exist, the serving base station (eNodeB 1) and the neighboring base station (eNodeB 2) may perform a process indicated by a dotted line in FIG. 19.

If the handover request received from the neighboring base station (eNodeB 2) is success in operation 1945, the serving base station (eNodeB 1) may transmit, to the UE, RRC ConnectionReconfiguration for HO in operation 1950.

In operation 1955, the UE may be reconfigured based on information contained in RRC ConnectionReconfiguration, and may transmit, to a target base station (eNodeB 2), an RRC message such as RRC ConnectionReconfiguration Complete.

In operations 1960 and 1965, the target base station (eNodeB 2) may transmit and receive, to and from aGW or MME, a procedure (Path Switch Request, Path Switch Request ACK) for a data path change defined in an S1AP protocol message. Through this, a handover is over.

Hereinafter, the HO decision and execution process of FIG. 19 may be described from viewpoint of each base station (eNodeB 1, eNodeB 2) will be described with reference to UE1 being positioned in the position 1820.

The flow 211 of FIG. 21A is a flowchart to describe the HO decision and execution process of FIG. 19 from viewpoint of a source base station.

When UE1 is positioned in the position 1820 of FIG. 18, a “serving (source) [CMC]” state indicates a state of eNodeB 1 of FIG. 19. Here, eNodeB 1 operates as a source base station and collects measurement data using RRC and CSAP. Based on the collected measurement data, the source base station (eNodeB 1) may perform the HO decision like operation 1930 of FIG. 19 through the following two operations.

A first operation is an operation of determining a handover based on a radio quality (e.g., in the case of UL, ULCCQ of Table 2, and in the case of DL, DLENBCCSNR of Table 3).

A second operation is an operation of analyzing and determining whether the determined handover is unnecessary based on the HO decision made in the first operation. The second operation corresponds to a selection.

When Inter-eNodeB HO is determined through the aforementioned two operations, the serving base station (eNodeB 1) may transmit, to UE, RRC ConnectionReconfiguration for HO in operation 2115, and may be shifted to a “neighboring (target) base station” state.

However, when it is not Inter-eNodeB HO, the serving base station (eNodeB1) may maintain the “serving (source) base station” state. Here, when information of (Parm 4-2-1 to 5) associated with a target base station to which the handover is determined in the first operation does not exist, the source base station (eNodeB 1) may transmit a message of operation 2118 (operation 1935 of FIG. 19) to the target base station for the prompt resource preparation of operation 1940. In response thereto, the source base station (eNodeB 1) may receive a message of operation 2119 from the target base station and thereby obtain information of (Parm 4-2-1 to 5) associated with the target base station.

In the HO decision shown in the flow 211 of FIG. 21A, TLI and ICI instruction from CMC or TLC of D-RRM of the same base station may occur. TLI and ICI may be to request exclusion of use of particular CC with respect to neighboring base stations in the CA environment. When the particular CC exists by comparing stored information (Parm 4-2-3, 4-2-4, 4-2-5) associated with the neighboring base stations, information may be updated through message exchange in operations 2118 and 2119.

A flow 203 of FIG. 20C is a flowchart to describe the HO decision and execution process of FIG. 19 from viewpoint of a neighboring (target) base station.

A “neighboring (target) [CMC]” state indicates that UE1 is positioned in the position 1820, and a state of the neighboring base station (eNodeB 2) of FIG. 19.

In operation 2031, a neighboring base station (eNodeB 2) may receive, from UE, RRC Connection Reconfiguration Complete for HO.

In operation 2032, the neighboring base station (eNodeB 2) may transmit, to MME, Path Switch Request (corresponding to operation 1965 of FIG. 19) that is an S1AP message, and may wait for Path Switch Request ACK.

When Path Switch Request ACK is received from MME in operation 2033, the neighboring base station (eNodeB 2) may be switched to a serving base station, which becomes a “serving (source) [CMC]” state.

<Flow 211 FIG. 21A: First Phase>

Hereinafter, the flow 211 of FIG. 21A will be described.

In operation 2111, UE may measure an SNR quality (DLENBCCSNR of Table 3) with respect to a reference signal for CC operated by neighboring base stations, and may generate event A3-1 from a measurement result.

Event A3-1 indicates a case where one of results of measuring DLENBCCSNR with respect to CCs of neighboring base stations becomes to be greater than DLENBCCSNR measurement value of each CC corresponding to UCcc of a current source base station (e.g., CC information used by UE1, i.e., (Parm 4-1-5) when a serving base station of UE1 is eNodeB 1). UCcc indicates a CC set used by current UE, and BCcc indicates a best CC set most appropriate for current UE.

In operation 1925 of FIG. 19, the UE may report to the serving base station (eNodeB 1) about event A3-1 that is a measurement result, in a form of a measurement report message. CMC of D-RRM of the serving base station (eNodeB 1) may also determine event A3-1 based on information within a message that is a periodical measurement value report form (operation 1925). In operation 1930, the serving base station (eNodeB 1) may review BCcc based on the measurement report message. The review result may be sorted in a descending order of a measured value. CC having greatest DLENBCCSNR may be determined as CC of a base station.

Referring again to the flow 211 of FIG. 21A, in operation 2112, when BCcc is determined based on a measurement value of DLENBCCSNR and when UCcc and BCcc correspond to inter-eNodeB (i.e., when BCcc is determined with respect to a neighboring base station instead of a current serving base station), the HO type described above with reference to the diagrams 821, 822, and 831 FIG. 8 may be determined. That UCcc and BCcc correspond to inter-eNodeB indicates that BCcc is determined with respect to the neighboring base station instead of the current serving base station.

BCcc may be determined based on information of the message of operations 1915 and 1940 of FIG. 19, and the message of operations 1920 and 1945, received from the neighboring base station. The information may be included in 4-2 message of Table 5. For example, in the case of inter-eNodeB, BCcc may be determined by the neighboring base station. A BCcc decision method (i.e., (Parm 4-2-3)) is described above with reference to the Advanced Resource Preparation process, and processing thereof is the same as Prompt Resource Preparation.

<Flow 211 of FIG. 21A: Second Phase>

When BCcc determined in operation 2112 indicates inter-eNodeB HO, it depends on DLENBCCSNR measurement value and thus, unnecessary handover such as ping pong may not be reduced. Accordingly, operation 2113 corresponding to the second phase may be additionally performed.

In operation 2113, the serving base station (eNodeB 1) may determine whether inter-eNodeB HO using the determined BCcc is unnecessary, based on accumulated history information.

According to an embodiment of the present invention, when a handover between base stations is performed in a state where UE1 is connected to a network, CMC of D-RRM of each base station may accumulate history information. CMC of D-RRM may verify a mobility pattern of UE1 based on the accumulated history information, and may secondarily verify whether handover to a target base station along the verified mobility pattern is appropriate.

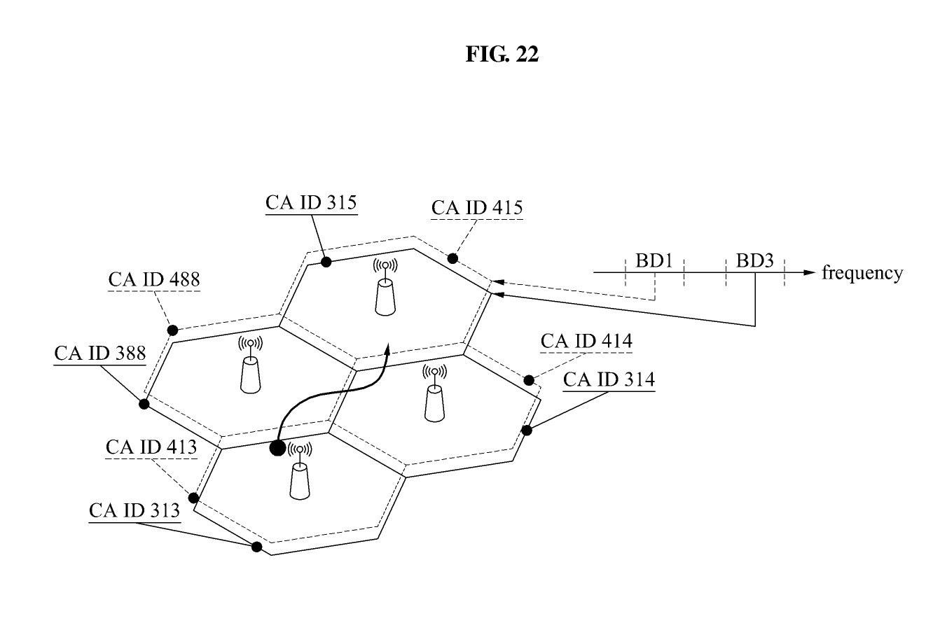

FIG. 22 is a diagram to describe a process of accumulating history information to be used in operation 2113 of FIG. 21A.

When a normal handover is performed along a mobility path of UE of FIG. 22, history information may be generated as given by Table. 6.

TABLE 6

| | Index | | | |
|---|---|---|---|---|
| | 0 | 1 | 2 | 3 |
| CA ID | 413 | 488 | 414 | 415 |
| CA ID | 313 | None | 314 | 315 |
| Cell type | Medium (413) | Medium (488) | Medium (414) | Medium |
| (BD1) | | | | (415) |
| Cell type | Medium (313) | None | Medium (314) | Medium |
| (BD3) | | | | (315) |
| Duration time of | 4095 (sec) | 350 (sec) | 120 (sec) | Recording |
| UE in eNodeB | | | | |
| If Inter-eNodeB | [413][488], [313], | [488][414], [388], | [414][415], [314], | |
| HO occurs, | [388] DL SNR set | [314] DL SNR | [315] DL | |
| DLENBCCSNR | | set | SNR set | |
| set (selection) | | | | |

Referring to Table 6, the stored history information may include CA ID, a cell type, a duration time of UE in eNodeB, and a signal quality measured for HO decision (i.e., DLENBCCSNR information of source CA-ID and DLENBCCSNR information of target base station CA-ID).

CA ID indicates an ID that may separate base stations and a frequency bandwidth used by each base station, and may configure the separated frequency bandwidth using a global unique value. When CA ID has DL frequency bandwidth (FB1, FB3) as shown in FIG. 2, and cell planning with respect to each base station (eNodeB) is performed, each base station may have a cell including FB1 and FB3.

Meanings contained in above CA ID may be separately expressed, and the separated meanings may be separately included in the history information. For example, CA ID may be separated into eNodeB ID, FB ID, cell ID, and the like, and thereby be recorded in the history information. Table 6 shows an example of history information with respect to each CA ID.

Specifically, when a normal handover is performed along the mobility path of UE in FIG. 22, CA ID used by UE in a previous serving base station, a cell type corresponding to CA ID, a duration time of the UE in the previous serving base station, and a DLENBCCSNR value when the handover to another serving base station is determined may be stored in CMC of D-RRM. The DLENBCCSNR value may include a DLENBCCSNR value of a serving base station and a DLENBCCSNR value of a target base station.

In Table 6, the cell type is classified into large, medium, and small. The cell type may be further classified. Also, the duration time of UE in CA may be indicated as an integer greater than or equal to, for example, “0”. When the duration time exceeds a predetermined maximum value, the duration time may be set as a maximum value and thereby be recorded.

Every time handover occurs, history information of Table 6 may be moved from the previous serving base station before the handover to the serving base station after the handover. Accordingly, the current serving base station may have the history information as shown in Table 6.

When the current serving base station (eNodeB 1) determines inter-eNodeB HO in operation 2112 of FIG. 21A, the serving base station (eNodeB 1) may determine whether inter-eNodeB HO is appropriate based on the history information stored in the serving base station (eNodeB 1) in operation 2113.

When inter-eNodeB HO from UCcc to BCcc is determined, the serving base station (eNodeB 1) may analyze a frequency, continuity, temporal property, and the like of a pattern from the stored history information, based on the determined matters, and may determine whether inter-eNodeB HO using the above pattern is appropriate.

The pattern corresponds to information determined in the aforementioned first phase, i.e., UCcc→BCcc. The frequency denotes a number of times that the pattern occurs in a corresponding history. The continuity denotes a state that the pattern is continuously repeated (e.g., eNodeB1 (DL−CC1, CC3)→eNodeB 2 (DL−CC3)→eNodeB1 (DL−CC1, CC3)→eNodeB 2 (DL−CC3)). The temporal property is to determine whether the pattern has occurred within a few minutes based on a current point in time. The temporal property may be classified into old information, intermediate information, and just previous information.

With respect to applying of the frequency, the continuity, and the temporal property for determining whether the HO using the pattern is appropriate, a priority and a combination scheme may be adjusted depending on a system operation circumstance. Selectively, a recorded DLENBCCSNR set may also be additionally used. For example, an algorithm may be designed so that a difference between currently measured DLENBCCSNR values and DLENBCCSNR measurement value of history information may be calculated and the DLENBCCSNR set may be excluded or be further considered depending on a calculation result.

<Flow 211 of FIG. 21A: First Phase>

An embodiment of the present invention using A3-1, A3-1′, and Rn when the BCcc determined in the flow 211 of FIG. 21A includes inter-eNodeB will be described.

As shown in FIG. 16, A3-1 indicates an event where DLENBCCSNR qualities of neighboring base stations become to be greater than DLENBCCSNR quality corresponding to UCcc of a serving base station. A3-1′ indicates an event where time-to-trigger or hysteresis that is a system operation parameter is not applied to A3-1

For example, A3-1 corresponds to an event that may manage mobility of UE, and may also quickly proceed or delay handover based on hysteresis or time-to-trigger when the hysteresis or the time-to-trigger exists. Specifically, A3-1 indicates that operation 2112 is performed using a measurement value to which hysteresis or time-to-trigger is applied. A3-1′ indicates that hysteresis=0 and time-to-trigger=0 and thus, operation 2112 is performed using a measurement value.

Rn is described as follows:

C_{HO(SS)}

```
  = { {c_{HO(SS)1-CC1,eNodeB2}, c_{HO(SS)2-CC1,eNodeB3}},
  {c_{HO(SS)3-CC2,eNodeB2,...}},...}
```

C_{HO(RE)}

= {{c_{HO(RE)1-CC1,eNodeB2}, c_{HO(RE)2-CC1eNodeB3}},

{c_{HO(RE)3-CC2,eNodeB2,...}},...}
P_{HO} = {{p_{HO1-CC1,eNodeB1}, p_{HO2-CC1,eNodeB3}}, {p_{HO3-CC2,eNodeB2,...}},...}
R_{HO} = {R_{HO(RES)-eNodeB2}, R_{HO(RES)-eNodeB3}}
R_{HO(RES)-eNodeB2 =} {CC₁}. R_{HO(RES)-eNodeB23=} {CC_{1,} CC2}

C_{HO(SS)} sorts, in a descending order for each CC, a quality measured with respect to DLENBCCSNR of neighboring base stations.

C_{HO(RE)} sorts, in a descending order for each CC, a difference between a quality measured with respect to DLENBCCSNR of neighboring base stations and a previously measured quality.

P_{HO} sorts, in a descending order of DLENBCCSNR for each CC, neighboring base stations having CC of DLENBCCSNR greater than communicable reference value (Thc).

R_{HO} indicates that information (4-2 information of Table 5) with respect to 1920 and 1940 is received through operations 1915 and 1940 of FIG. 19, and (Parm 4-2-2) is SUCCESS. For example, R_{HO(RES)-eNodeB2=}{CC₃} indicates that use of CC3 of eNodeB2 is permitted when Advanced Resource Preparation or Prompt Resource Preparation is performed from eNodeB1 to eNodeB2. Also, R_{HO(RES)-eNodeB3=}{CC₁,CC2} indicates that use of CC1 and CC2 of eNodeB 3 is permitted when Advanced Resource Preparation or Prompt Resource Preparation is performed from eNodeB1 to eNodeB3.

Events occurring when orders of C_{HO(SS)}, C_{HO(RE)}, and P_{HO} are changed are defined as R1, R2, and R3, respectively.

Hereinafter, a method for inter-eNodeB HO in a wireless mobile communication system using CA based on the aforementioned information will be briefly described.

When a serving base station connected by UE may determine BCcc based on only a measurement value of DLENBCCSNR, and when the determined BCcc indicates inter-eNodeB and BCcc∉R_{HO}, the serving base station may perform prompt resource preparation through operations 1935 through 1945 of FIG. 19.

When (Parm 4-2-2) of a message transmitted from a corresponding neighboring base station is a success, the serving base station may update BCcc with (Parm 4-2-3). According to an embodiment of the present invention, when BCcc∉R_{HO} even though advanced resource preparation is performed, TLC may compulsorily release a resource reserved for handover resource preparation so as to manage load.

Hereinafter, a case where the preparation process of FIG. 13 (advanced resource preparation or prompt resource preparation) is performed, that is, a case where BCcc E R_{HO} will be described.

When the serving base station connected by the UE determines BCcc based on only the measurement value of DLENBCCSNR, and when the determined BCcc indicates inter-eNodeB, and (Parm 4-2-3) to a corresponding target base station is prepared, a handover may be immediately performed, or prompt resource preparation may be performed again through operations 1935 through 1945. Here, when the prepared (Parm 4-2-3) is not used, DLENBCCSNR signal quality with respect to stored CC determined by (Parm 4-2-3) may be relatively low.

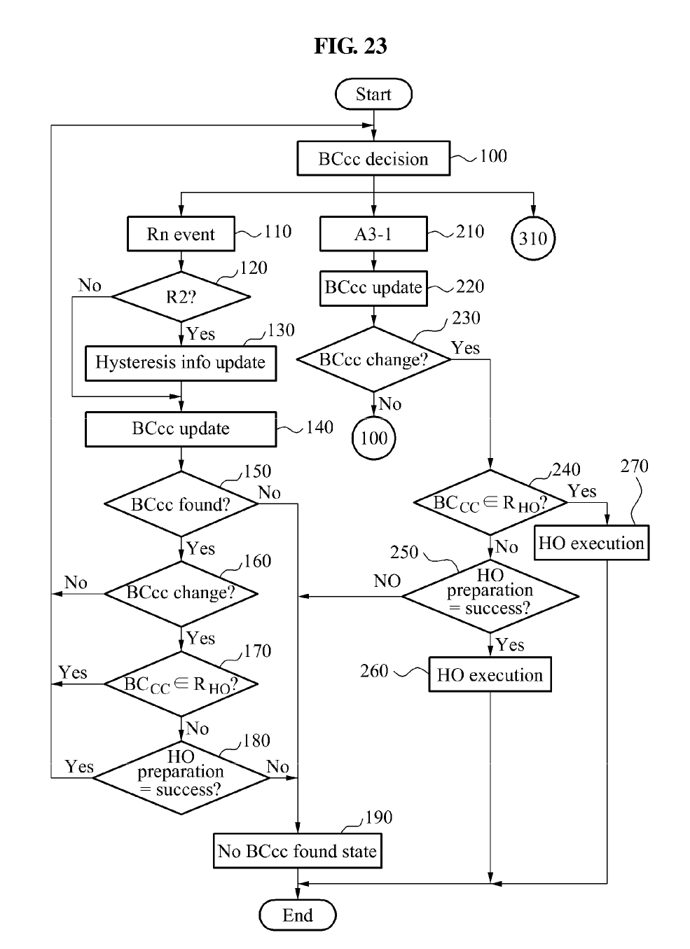

FIG. 23 through FIG. 25 are flowcharts to describe operation 2112 of operation 211 of FIG. 21A according to an embodiment of the present invention.

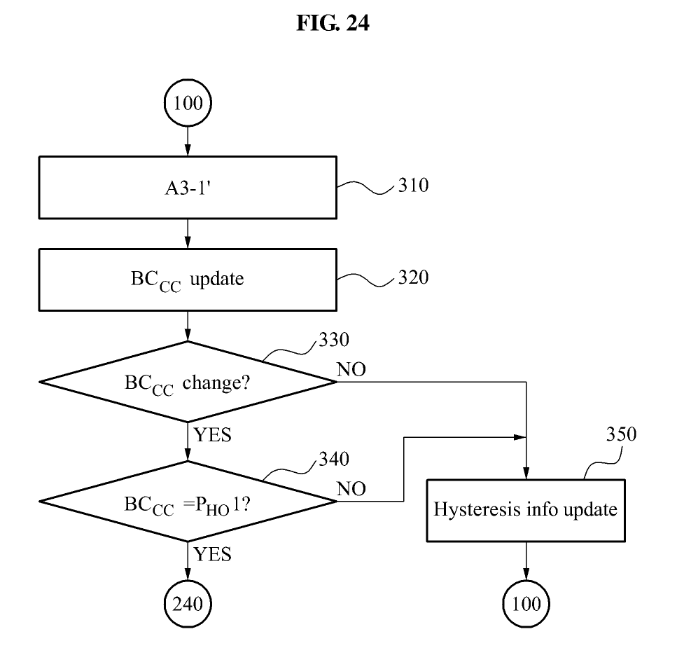

FIG. 23 and FIG. 24 are flowcharts to describe a method of perform inter-eNodeB HO using a signal strength required to request the aforementioned RRC connection reconfiguration when BCcc is determined by the serving base station. Updating of hysteresis information is described later.

Referring to FIG. 23, in operation 100, a serving (source) base station may determine BCcc to be used by a UE.

In operation 110, when the determined BCcc corresponds to inter-eNodeB, event Rn may occur in the serving (source) base station.

When Rn=R2 in operation 120, the serving (source) base station may perform hysteresis information update as shown in Table 7 with respect to DLENBCCSNR of a corresponding base station in operation 130.

In operation 140, the serving (source) base station may reconsider and update BCcc by applying the updated hysteresis information.

When BCcc to be used by the UE is found in the updated BCcc in operation 150, the serving (source) base station may determine whether the found BCcc is changed compared to previous BCcc in operation 160.

When not changed, the serving (source) base station may go to operation 100 to wait for an event.

Conversely, when changed, the serving (source) base station may determine whether the changed BCcc is included in R_{HO} in operation 170.

When BCcc is not included in R_{HO}, the serving (source) base station may perform prompt resource preparation (operations 1935 through 1945 of FIG. 19) in operation 180, and then enter a BCcc found state of operation 100 to wait for a subsequent event.

When a prompt preparation of operation 180 fails, the serving (source) base station 100 may enter a no BCcc found state in operation 190.

Conversely, when the changed BCcc is included in R_{HO} in operation 170, the serving (source) base station may enter the BCcc found state of operation 100 to wait for the subsequent operation.

When event A3-1 occurs by applying new history information and time-to-trigger in operation 210, the serving (source) base station may update BCcc in operation 220.

When the updated BCcc is determined to be changed in operation 230, and when the changed BCcc is not included in R_{HO} in operation 240, the serving (source) base station may perform prompt resource preparation (operations 1935 through 1945 of FIG. 19) in operation 250.

When the prompt resource preparation succeeds, the serving (source) base station may transmit 1950 of FIG. 19 to the UE in operation 260.

Conversely, when the updated BCcc is determined to be not changed in operation 230, the serving (source) base station may enter the BCcc found state of operation 100 to wait for the subsequent operation.

Also, when the changed BCcc is included in R_{HO} in operation 240, the prompt resource preparation (operations 1935 through 1945 of FIG. 19) may be omitted, and the serving (source) base station may transmit 1950 of FIG. 19 to UE in operation 270.

When event A3-1′ to which the new hysteresis and time-to-trigger is not applied occurs in operation 310 of FIG. 24, the serving (source) base station may update BCcc in operation 320.

When the updated BCcc is determined to be changed in operation 330, and when the changed BCcc=P_{HO}1 of the same serving (source) base station in operation 340, the serving (source) base station may determine whether to perform preparation (operations 1935 through 1945 of FIG. 19) depending on belonging of R_{HO}. Specifically, when the changed BCcc=P_{HO}1 of the same serving (source) base station in operation 340, the serving (source) base station may perform operations 240 through 270.

Also, when the changed BCcc≠P_{Ho}1 of the same serving (source) base station in operation 340, the serving (source) base station may update hysteresis information in operation 350. Specifically, BCcc may affect update by applying the changed hysteresis.

Also, when the changed BCcc≠P_{HO}1 of the same serving (source) base station in operation 340, the serving (source) base station may perform operation 240.

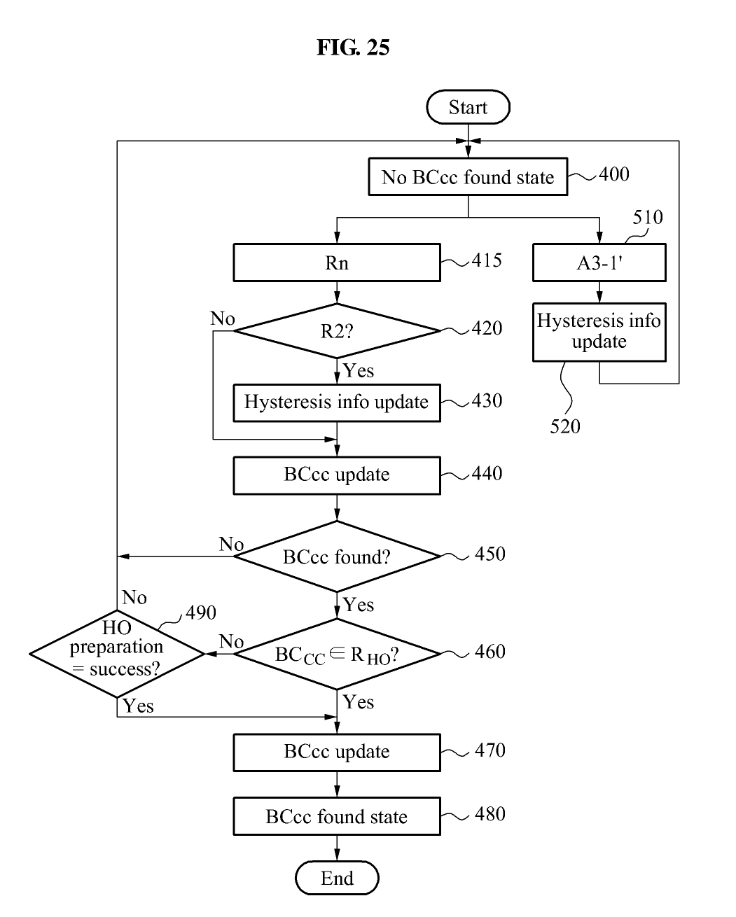

FIG. 25 is a flowchart to describe a method of performing inter-eNodeB HO using a signal strength required to request the aforementioned RRC connection reconfiguration when BCcc is not determined by a source base station.

When BCcc is not determined by the serving (source) base station and thereby, the serving (source) base station is in no BCcc found state in operation 400, the serving (source) base station may trigger event Rn in operation 415.

When Rn=R2 in operation 420, the serving (source) base station may update hysteresis information as shown in Table 7 in operation 430.

In operation 440, the serving (source) base station may update BCcc by applying the updated hysteresis information.

When BCcc to be used by UE is found in the updated BCcc in operation 450, the serving (source) base station may determine whether BCcc is included in R_{HO} in operation 460.

When BCcc is included in R_{HO} in operation 460, the serving (source) base station may update the found BCcc in operation 470 and may enter a BCcc found state in operation 480.

Conversely, when BCcc is not included in R_{HO} in operation 460, and when prompt resource preparation (operations 1935 through 1945 of FIG. 19) succeeds in operation 490, the serving (source) base station may go to operation 470. Conversely, when the prompt resource preparation (operations 1935 through 1945 of FIG. 19) fails in operation 490, the serving (source) base station may go to operation 400 to wait for Rn or A3-1′ in the no BCcc found state.

When A3-1 occurs in operation 510, the serving (source) base station may update hysteresis information as shown in Table 7 in operation 520 and then go to operation 400.

<Hysteresis Information Update Described in FIGS. 23 Through 25>

Hysteresis information update of FIGS. 23 through 25 may be applied as follows:

Initially, a magnitude of a change amount is predefined as LARGE, MEDIUM, and SMALL based on a change amount (CHO(RE)) level of DLENBCCSNR for each CC and for each current base station. Also, a difference between a minimum value and a maximum value of applicable hysteresis is also predefined as LARGE, MEDIUM, and SMALL. This is to induce handover to be performed with respect to CC having increasing CHO(RE) rather to select CC having a greatest DLENBCCSNR, and to delay a handover with respect to CC having decreasing CHO(RE). Classification of the above value may need tuning according to a system.

For example, CHO(RE) Large is defined as at least 20, MEDIUM is defined as 19 to 10, and SMALL is defined as less than 9. Hysteresis LARGE is defined as at least 10, MEDIUM is defined as 9 to 5, and SMALL is defined as less than 4. Also, “delta hysteresis” is defined as 2.

It is assumed that a radio quality (i.e., DLENBCCSNR) with respect to CC1 of a neighboring base station is previously 10 and currently 10, a radio quality with respect to CC2 is previously 5 and currently 18, a radio quality with respect to CC3 is previously 3 and currently 50, and hysteresis being applied to CC1, CC2, and CC3 are 11, 3, and 8.

Here, CHO(RE)CC1 is 5, CHO(RE)CC2 is 13, and CHO(RE)CC3 and 47. When they are classified according to the above classes, CHO(RE)CC1 is SMALL, CHO(RE)CC2 is MEDIUM, and CHO(RE)CC3 is LARGE.

With respect to CC1, CHO(RE) is SMALL and current hysteresis is 11 corresponding to LARGE and thus, current hysteresis may increase by the delta hysteresis. Accordingly, new hysteresis becomes 13 according to Table 7.

With respect to CC2, CHO(RE) is MEDIUM and current hysteresis is 3 corresponding to SMALL and thus, current hysteresis may be maintained by the delta hysteresis. Accordingly, new hysteresis may be 3 that is the previous hysteresis according to Table 7.

With respect to CC3, CHO(RE) is LARGE and current hysteresis is 8 corresponding to MEDIUM and thus, current hysteresis may decrease by the delta hysteresis. Accordingly, new hysteresis becomes 6 according to Table 7.

TABLE 7

| IF | AND | THEN |
|---|---|---|
| C_{HO(RE)i} | Current Hysteresis is | Hysteresis is |
| LARGE | LARGE | DECREASE |
| LARGE | MEDIUM | DECREASE |
| LARGE | SMALL | DECREASE |
| MEDIUM | LARGE | MAINTAIN |
| MEDIUM | MEDIUM | MAINTAIN |
| MEDIUM | SMALL | MAINTAIN |
| SMALL | LARGE | INCREASE |
| SMALL | MEDIUM | INCREASE |
| SMALL | SMALL | INCREASE |

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of determining a handover type of a serving base station being currently connected by a user equipment in a wireless mobile communication system using a carrier aggregation, the method comprising:
collecting measurement information required to determine an optimal frequency band set to be used for the handover;
performing data processing of the collected measurement information to determine a temporary frequency band set for a downlink handover or an uplink handover; and
determining the optimal frequency band set for the downlink handover or the uplink handover, depending on whether the determined temporary frequency band set supported by the serving base station and whether the determined temporary frequency band set supported by a neighboring base station of the serving base station.

2. The method of claim 1, wherein the collecting comprises collecting, by the serving base station, information measured by the user equipment using a Radio Resource Control (RRC) interface, information measured within the serving base station, received using a Control Service Access Point (CSAP) interface, and resource information of the neighboring base station using an X2 interface.

3. The method of claim 1, wherein the performing of the data processing comprises performing radio condition related processing, traffic load processing, and interference related processing based on the collected measurement information.

4. The method of claim 1, wherein when the determined temporary frequency band set corresponds to the optimal frequency band set for the downlink handover and supported by the neighboring base station, the determining of the optimal frequency band set comprises selecting, from the neighboring base station or the serving base station, the optimal frequency band set for the uplink handover.

5. The method of claim 4, further comprising:
determining a type of the downlink handover based on a number of frequency bands with respect to a downlink being currently used by the user equipment and a number of frequency bands included in an optimal frequency band set with respect to the downlink when the optimal frequency band set for the uplink handover is selected from the neighboring base station.

6. The method of claim 5, further comprising:
determining a type of the uplink handover based on a number of frequency bands with respect to an uplink being currently used by the user equipment and a number of frequency bands included in an optimal frequency band set with respect to the uplink.

7. The method of claim 1, wherein when the determined temporary frequency band set corresponds to the optimal frequency band set for the uplink handover and supported by the neighboring base station, the determining of the optimal frequency band set comprises selecting, from the neighboring base station or the serving base station, the optimal frequency band set for the downlink handover.

8. The method of claim 7, further comprising:
determining a type of the downlink handover based on a number of frequency bands with respect to a downlink being currently used by the user equipment and a number of frequency bands included in an optimal frequency band set with respect to the downlink when the optimal frequency band set for the downlink handover is selected from the neighboring base station.

9. The method of claim 8, further comprising:
determining a type of the uplink handover based on a number of frequency bands with respect to an uplink being currently used by the user equipment and a number of frequency bands included in an optimal frequency band set with respect to the uplink.

10. A serving base station for determining a type of a handover type of a user equipment in a wireless mobile communication system using a carrier aggregation, the serving base station comprising:
a collecting unit to collect measurement information required to determine an optimal frequency band set to be used for the handover;
a data processor to perform data processing of the collected measurement information, and to thereby determine a temporary frequency band set for a downlink handover or an uplink handover; and
a determining unit to determine the optimal frequency band set for the downlink handover or the uplink handover, depending on whether the determined temporary frequency band set supported by the serving base station and whether the determined temporary frequency band set supported by a neighboring base station of the serving base station.

11. The serving base station of claim 10, wherein the collecting unit collects information measured by the user equipment using a Radio Resource Control (RRC) interface, information measured within the serving base station, received using a Control Service Access Point (CSAP) interface, and resource information of the neighboring base station using an X2 interface.

12. The serving base station of claim 10, wherein the data processor performs radio condition related processing, traffic load processing, and interference related processing based on the collected measurement information.

13. The serving base station of claim 10, wherein when the determined temporary frequency band set corresponds to the optimal frequency band set for the downlink handover and supported by the neighboring base station, the determining unit selects, from the neighboring base station or the serving base station, the optimal frequency band set for the uplink handover.

14. The serving base station of claim 10, wherein when the determined temporary frequency band set corresponds to the optimal frequency band set for the uplink handover and supported by the neighboring base station, the determining unit selects, from the neighboring base station or the serving base station, the optimal frequency band set for the downlink handover.

15. A method for a handover between base stations in a wireless mobile communication system using a carrier aggregation, the method comprising:
receiving and storing measurement information associated with neighboring base stations positioned around a serving base station;
analyzing the measurement information to determine, as a candidate group, resources of neighboring base stations having a downlink quality greater than a reference value;
reserving a resource of a neighboring base station having a greatest downlink quality in the candidate group as a resource to be used for a handover of a user equipment;
performing the handover of the user equipment to the neighboring base station having the greatest downlink quality through the reserved resource; and
cancelling the reserved resource when the downlink quality of the reserved resource becomes to be less than the reference value.

16. The method of claim 15, wherein the measurement information is received using a Radio Resource Control (RRC) interface and a Control Service Access Point (CSAP) interface, and the serving base station exchanges information with the neighboring base stations using an X2 interface to thereby prepare the resource.

17. The method of claim 15, wherein the measurement information corresponds to downlink measurement information for each component carrier available frequency band with respect to the serving base station and the neighboring base stations.

18. The method of claim 15, wherein the reserving comprises reserving the resource to be used for the handover by further using history information regarding a handover between the serving base station and the neighboring base stations.

19. The method of claim 18, wherein:
the history information corresponds to information used by the serving base station when the user equipment is handed over, and
the method further comprises:
analyzing, for each carrier aggregation based on the history information, a frequency
of the user equipment moving from a current carrier aggregation to another carrier aggregation when the handover of the user equipment is determined; and
performing the handover to a CA having a greatest frequency of the user equipment.
